(19) United States
(12) Patent Application Publication
(10) Pub. No.: US 2026/0093375 A1
(43) Pub. Date: Apr. 2, 2026

(54) SYSTEMS AND METHODS FOR ENHANCED INSTRUCTION IN VIRTUAL REALITY INTERACTIONS

(71) Applicant: State Farm Mutual Automobile Insurance Company, Bloomington, IL (US)

(72) Inventors: Jody A. Thoele, Bloomington, IL (US); Antonio Cunanan, Richardson, TX (US); Wesley Mao, Murphy, TX (US); David Herrera, Bloomington, IL (US)

(21) Appl. No.: 19/329,688

(22) Filed: Sep. 16, 2025

Related U.S. Application Data
(60) Provisional application No. 63/700,033, filed on Sep. 27, 2024.

(51) Int. Cl. G06F 3/04815; G06N 20/00

(52) U.S. Cl. CPC G06F 3/04815; G06N 20/00

(57) ABSTRACT

A computing system is provided. The computing system may be configured or programmed to: i) communicate with a trainee computing devices to present a virtual instructional environment; ii) receive sensor data from at least one of the trainee computing device associated with the trainee and a client computing device associated with a client; iii) evaluate the current interaction between the trainee and the client by applying the received sensor data associated with the current interaction to a trained instructional recommendation model to generate an instructional recommendation message including a script for the trainee to communicate during the current interaction; and iv) present, within the virtual instructional environment, the instruction message

### CROSS-REFERENCE TO RELATED APPLICATIONS

This application claims the benefit of priority to U.S. Provisional Patent Application No. 63/700,033, filed Sep. 27, 2024, entitled “SYSTEMS AND METHODS FOR ENHANCED INSTRUCTION IN VIRTUAL REALITY INTERACTIONS,” the entire content and disclosure of which is hereby incorporated herein by reference in its entirety.

### FIELD OF DISCLOSURE

The present disclosure relates to enhanced virtual reality interactions and, more particularly, to network-based systems and methods for generating a virtual reality instructional environment and facilitating instruction of a trainee through the virtual reality instructional environment.

### BACKGROUND

The metaverse is designed for millions of users to interact with each other at any moment in time, as well as 24 hours a day, 7 days a week, all of the time. Since the metaverse may be a hosted virtual reality, individual users may desire to interact with other individuals through an avatar, both real and fictional. However, live individuals, either as an avatar or as a live person, may only be able to interact with one or a few users at a time and may not be available all of the time.

In the metaverse, it may also be desirable to increase trust and confidence of the user in the individuals interacting with the user within the metaverse, and for the individuals to appropriately respond to any questions, statements, gestures, or an emotional state of the user displayed within the metaverse. Conventional techniques may include additional inefficiencies, encumbrances, ineffectiveness, and/or other drawbacks as well.

### BRIEF SUMMARY

The present embodiments may relate to, inter alia, computer systems and computer-based methods for enhanced virtual reality interaction. In the exemplary embodiment, the systems and methods may generate a VR (virtual reality) instructional environment that includes (i) one or more avatars, and/or (ii) one or more virtual locations that may be visited by a user avatar controlled by a user with a user computing device (e.g., an AR (augmented reality) or VR headset and/or other AR or VR system). These virtual locations may include places of business, such as insurance agencies, or other locations having real-world counterparts, and may be occupied by user avatars (e.g., if the instructor is available live) and/or avatars associated with a replica persona of the instructor (e.g., if the instructor is not available live). By visiting locations virtually, the user may purchase products, obtain information about the business, and/or collaborate with other users, for example, by viewing overlays or aspects of the VR instructional environment itself (e.g., virtual signage or documents included in the VR instructional environment) and/or by interacting with an avatar associated with the corresponding virtual user (e.g., by asking questions and receiving responses from the virtual user or the virtual user's virtual replicant).

Further, by visiting and interviewing in a virtual setting, the user does not need to physically travel to interact with different instructors, therefore making it easier for users in remote locations to interact with one or more instructors or other virtual users, and also making it easier for users to identify an instructor having attributes (e.g., background, affinity, demographics, technical skills, language skills, experience, education, hobbies, etc.) compatible with or considered desirable by the user. For example, by visiting one or more virtual locations, users can get to know different instructors by interviewing and/or viewing information (e.g., introductory videos) relating to the instructor. Additionally, data provided by the user or instructor may be recorded and stored in a database, so that the data may be retrieved seamlessly for future interactions within the VR instructional environment and for traditional interactions outside of the VR instructional environment. For instance, records of interactions within the virtual instructional environment may be used to process any transactions that may have occurred within the virtual instructional environment, or may be analyzed for instructional purposes.

In one aspect, a virtual reality computing system for conducting instructional interactions between one or more user computing devices including a trainee computing device within a virtual environment may be provided. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may include at least one processor and/or associated transceiver in communication with at least one memory device and in communication with a user computing device associated with a user and with an interface of user computing device associated with an instructor. The at least one processor may be programmed to: i) communicate with the one or more user computing devices including the trainee computing device associated with a trainee to cause the one or more user computing devices to present the virtual environment, wherein the virtual environment includes a client avatar representing a client interacting with the trainee in an instructional exercise; (ii) receive sensor data from the trainee computing device associated with the trainee and a user computing device associated with the client during a current interaction between the trainee and the client within the virtual environment; (iii) evaluate the current interaction between the trainee and the client by inputting the received sensor data into a trained machine learning (ML) model to generate one or more outputs including an instructional message that includes scripted text for the trainee to communicate to the client during the current interaction within the virtual environment; and (iv) present, on the trainee computing device, the instructional message. The computing system may have additional, less, or alternate functionality, including that discussed elsewhere herein.

In another aspect, a computer-implemented method for conducting interactions between a plurality of user computing devices including a trainee computing device within a virtual environment may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, ChatGPT or ChatGPT-based bots, and/or other electronic or electrical components, which may be in wired or wireless communication with one another. For example, in one instance, the computer-implemented method may be implemented by a computing system including at least one processor and/or associated transceiver in communication with at least one memory device and in communication with a user computing device associated with a user and with an interface of user computing device associated with an instructor. The method may include: i) communicating with the one or more user computing devices including the trainee computing device associated with a trainee to cause the one or more user computing devices to present the virtual environment, wherein the virtual environment includes a client avatar representing a client interacting with the trainee in an instructional exercise; (ii) receiving sensor data from the trainee computing device associated with the trainee and a user computing device associated with the client during a current interaction between the trainee and the client within the virtual environment; (iii) evaluating the current interaction between the trainee and the client by inputting the received sensor data into a trained machine learning (ML) model to generate one or more outputs including an instructional message that includes a scripted text for the trainee to communicate to the client during the current interaction within the virtual environment; and (iv) presenting, on the trainee computing device, the instructional message. The method may include additional, less, or alternate actions, including those discussed elsewhere herein.

In yet another aspect, at least one non-transitory computing-readable media having computing-executable instructions embodied thereon for conducting instructional interactions between one or more user computing devices including a trainee computing device within a virtual environment may be provided. The computing-executable instructions may be executed by a computing system including at least one local or remote processor and/or associated transceivers in communication with at least one local or remote memory device and in communication with a user computing device associated with a user and with an interface of user computing device associated with an instructor. The computing-executable instructions may direct or cause the at least one processor to: i) communicate with the one or more user computing devices including the trainee computing device associated with a trainee to cause the one or more user computing devices to present the virtual environment, wherein the virtual environment includes a client avatar representing a client interacting with the trainee in an instructional exercise; (ii) receive sensor data from the trainee computing device associated with the trainee and a user computing device associated with the client during a current interaction between the trainee and the client within the virtual environment; (iii) evaluate the current interaction between the trainee and the client by inputting the received sensor data into a trained machine learning (ML) model to generate one or more outputs including an instructional message that includes scripted text for the trainee to communicate to the client during the current interaction within the virtual environment; and (iv) present, on the trainee computing device, the instructional message. The computing-executable instructions may direct additional, less, or alternate functionality, including that discussed elsewhere herein.

In another aspect, a computing system for generating a virtual reality replicant persona for interaction with at least one user may be provided. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may include at least one processor and/or associated transceiver in communication with at least one memory device and in communication with a user computing device associated with a user and with an interface of user computing device associated with an instructor. The at least one processor may be programmed to: i) communicate with the one or more trainee computing devices each associated with a trainee to cause the one or more trainee computing devices to present the virtual instructional environment, wherein the virtual instructional environment is associated with an instructional exercise, the virtual instructional environment including a client avatar representing a client for virtual interactions with the trainee; ii) receive sensor data from at least one of the trainee computing device associated with the trainee and a client computing device associated with the client during a current interaction between the trainee and the client; iii) evaluate the current interaction between the trainee and the client by applying the received sensor data associated with the current interaction to a trained instructional recommendation model to generate one or more outputs including an instructional recommendation message including scripted text for the trainee to communicate during the current interaction; and/or iv) present, within the virtual instructional environment, to the trainee user computing device, the instructional recommendation message. The computing system may have additional, less, or alternate functionality, including that discussed elsewhere herein.

In another aspect, a computer-implemented method for generating a virtual reality replicant persona for interaction with at least one user may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, ChatGPT or ChatGPT-based bots, and/or other electronic or electrical components, which may be in wired or wireless communication with one another. For example, in one instance, the computer-implemented method may be implemented by a computing system including at least one processor and/or associated transceiver in communication with at least one memory device and in communication with a user computing device associated with a user and with an interface of user computing device associated with an instructor. The method may include: i) communicating with the one or more trainee computing devices each associated with a trainee to cause the one or more trainee computing devices to present the virtual instructional environment, wherein the virtual instructional environment is associated with an instructional exercise, and the virtual instructional environment including a client avatar representing a client for virtual interactions with the trainee; ii) receiving sensor data from at least one of the trainee computing device associated with the trainee and a client computing device associated with the client during a current interaction between the trainee and the client; iii) evaluating the current interaction between the trainee and the client by applying the received sensor data associated with the current interaction to a trained instructional recommendation model to generate one or more outputs including an instructional recommendation message including scripted text for the trainee to communicate during the current interaction; and/or iv) presenting, within the virtual instructional environment, to the trainee user computing device, the instructional recommendation message. The method may include additional, less, or alternate actions, including those discussed elsewhere herein.

In yet another aspect, at least one non-transitory computing-readable media having computing-executable instructions embodied thereon may be provided. The computing-executable instructions may be executed by a computing system including at least one local or remote processor and/or associated transceivers in communication with at least one local or remote memory device and in communication with a user computing device associated with a user and with an interface of user computing device associated with an instructor. The computing-executable instructions may direct or cause the at least one processor to: i) communicate with the one or more trainee computing devices each associated with a trainee to cause the one or more trainee computing devices to present the virtual instructional environment, wherein the virtual instructional environment is associated with an instructional exercise, the virtual instructional environment including a client avatar representing a client for virtual interactions with the trainee; ii) receive sensor data from at least one of the trainee computing device associated with the trainee and a client computing device associated with the client during a current interaction between the trainee and the client; iii) evaluate the current interaction between the trainee and the client by applying the received sensor data associated with the current interaction to a trained instructional recommendation model to generate one or more outputs including an instructional recommendation message including scripted text for the trainee to communicate during the current interaction; and/or iv) present, within the virtual instructional environment, to the trainee user computing device, the instructional recommendation message. The computing-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the computer systems and computer-based methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a schematic diagram of an exemplary instructional computing system for interaction with at least one user in a virtual instructional environment according to an exemplary embodiment of the present disclosure.

FIG. 2 illustrates a simplified block diagram of an exemplary computing system for use with the exemplary instructional computing system shown in FIG. 1.

FIG. 3 illustrates an example instructional exercise including a virtual instructional environment for use with the exemplary instructional computing system shown in FIG. 1.

FIG. 4 illustrates an exemplary configuration of a user computing according to an exemplary embodiment of the present disclosure.

FIG. 5 illustrates an exemplary configuration of an instructional computing device according to an exemplary embodiment of the present disclosure.

FIG. 6 illustrates a flow chart of an exemplary computer-implemented process for interaction with at least one user in a virtual instructional environment according to an exemplary embodiment of the present disclosure.

FIG. 7 is a continuation of the flow chart illustrated in FIG. 6.

FIG. 8 illustrates a flow chart of an exemplary computer-implemented process for generating an avatar for an instructor or other individual according to an exemplary embodiment of the present disclosure.

FIG. 9 depicts a flow chart of an exemplary computer-implemented process for providing a secure data exchange in a virtual instructional environment such as the virtual instructional environment described as an exemplary embodiment of the present disclosure.

FIG. 10 depicts a flow chart of an exemplary computer-implemented process for providing real time instructional recommendations in a virtual instructional environment described as an exemplary embodiment of the present disclosure.

FIG. 11 depicts a flow chart of an exemplary computer-implemented process for generating an instructional recommendation during an instructional exercise.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

As described herein, a replicant persona may be, inter alia, an artificial intelligence (AI) driven digital recreation of an individual, such as, but not limited to, virtual users, physical space users, instructors, trainees, clients, and/or any suitable representatives associated with a business and/or other individuals. These replicant personas may include real and fictional human or non-human individuals. The replicant persona may be trained to simulate a personality of an individual within a virtual environment including replicating the traits of the individual including, but not limited to, their mannerisms, appearance, personality, historical and conversational talking points of an actual, real-life person.

Also, as described herein, an avatar may be an audio and/or visual representation of the individual being controlled by the replicant persona. In the exemplary embodiment, an avatar may be used to interact with virtual reality users, in particular a trainee and an instructor, within in a virtual reality environment. In some embodiments, there may be multiple avatars for the same replicant persona. For example, multiple avatars for an individual may be in multiple locations in the virtual reality environment.

In the exemplary embodiment, an avatar may be connected to the replicant persona, where the replicant persona controls the actions and reactions of the individual avatars. For example, if a question is asked of the avatar, the question may be routed to the replicant persona, which formulates a response and transmits the response to the avatar. In some embodiments, a single replicant persona may control multiple avatars simultaneously. In some examples, an avatar may be performing as a virtual instructor to instruct a trainee in selling an insurance policy and/or other products, receive and/or process insurance claims, and/or provide information and/or answer general insurance-related questions within the metaverse. In other words, an avatar associated with a replicant persona may be a virtual instructor or trainee avatar and may explain or offer insurance and/or other products to a user, e.g., a client, directly, or via a user avatar of a trainee and/or an instructor as described below.

For the purposes of this discussion, a user avatar may be an audio and/or visual representation of a user that is directly controlled by that user within a virtual reality environment. The user avatar may be controlled via the user computing device as the user is logged into the virtual reality environment. In some embodiments, the user avatar may be a direct representation of the user. In other embodiments, the user avatar may be anything that the user wishes to be within the virtual reality embodiment (such as animal or imaginary creature, e.g., unicorn, dragon, flying rabbit, etc.). The user may be able to modify their user avatar to change its appearance, such as by changing the appearance, clothing, hairstyle, skin or fur color, size, demeanor, and other attributes of the user avatar. In some embodiments, a user avatar may be associated with an account of the user. In some of these embodiments, the user may have more than one account and therefore multiple user avatars. In some further embodiments, the user may have multiple user avatars associated with their account and use different ones at different times.

As used herein, “VR instructional environment” or “virtual instructional environment” refers to a digital or virtual instructional environment experienced by or displayed to a user through a VR (virtual reality) computing device. In other words, “VR instructional environment” refers to the VR view and functionality experienced by a user through a VR enabled computing device. Conversely, any virtual or digital environment displayed to a user through a VR computing device may be considered a VR instructional environment.

As used herein, “AR environment” refers to a digital or virtual instructional environment overlaid on a real-world environment and experienced by a user through a VR/AR (Augmented Reality) computing device. In other words, “AR environment” refers to the AR display and functionality experienced by a user through an AR enabled computing device. Mixed or eXtended reality (XR) devices may also be used for input and/or output.

In some further embodiment, the VR and/or AR may allow for haptic responses to allow the user to feel an interaction with an object. The haptic response may be provided through the use of gloves or other feedback devices. In one embodiment, the haptic response may allow the user to feel the texture of the 3-D object and/or the weight of the 3-D object. For example, the user may shake the avatar's hand or receive a virtual object from the avatar, and the user may be able to feel the handshake, or the object being handed to the avatar.

The present embodiments may relate to, inter alia, systems and methods for enhanced virtual reality interactions. In the exemplary embodiment, the systems and methods may generate a VR instructional environment that includes (1) one or more avatars, and/or (2) one or more virtual locations that may be visited by a user avatar controlled by a user with a user computing device (e.g., an AR or VR headset and/or other AR or VR system). These virtual locations may include places of business, such as insurance agencies or other types of businesses, having real-world counterparts, and may be occupied by user avatars (e.g., if the instructor is available live) and/or avatars associated with a replica persona of the instructor (e.g., if the instructor is not available live). In some cases, a virtual location may be based on an actual geographic location. By visiting the locations virtually, the user may purchase products or obtain information about the business or various products/services, for example, by viewing overlays or aspects of the VR instructional environment itself (e.g., virtual signage or documents included in the VR instructional environment) and/or by interacting with an avatar associated with the corresponding instructor (e.g., by asking questions and receiving responses from the instructor or the instructor's virtual replicant).

By visiting and interviewing instructors in a virtual setting, the user does not need to physically travel to interact with different instructors, therefore making it easier for trainees in remote locations to interact with one or more instructors, and also making it easier for users identify an instructor having attributes (e.g., background, affinity, demographics, technical skills, language skills, experience, education, hobbies, etc.) compatible with or considered desirable by the trainee. For example, by visiting one or more virtual locations, users may get to know different instructors by interviewing and/or viewing information (e.g., introductory videos) relating to the instructor.

Additionally, data provided by the user or instructor may be recorded and stored in a database, so that the data may be retrieved seamlessly for future interactions within the VR instructional environment or the instructional computing system, e.g., to evaluate the performance of the trainee and/or the instructor. Additional, data collected during an instructional exercise may also be used for traditional interactions outside of the VR instructional environment. For example, records of interactions within the virtual instructional environment may be used to process any transactions that may have occurred within the virtual instructional environment.

The system may further provide a secure exchange of training documents and/or other data using a virtual file cabinet for storing instruction documents. The virtual file cabinet may enable a user to securely store actual or sample instruction documents and to authorize other users to access the instruction documents. For example, an instructor may, through input (e.g., within the virtual instructional environment, a mobile app, and/or web page) designate instruction documents (e.g., instruction recommendation messages, insurance policy documents, insurance cards, insurance claim files, financial or other accounts, and/or documents and/or other data relating to insurance claims) to be stored in the virtual file cabinet, or the instruction documents may automatically be stored in association with the virtual file cabinet in response to certain events (e.g., an event triggering an instruction evaluation, purchase or renewal of an insurance policy and/or filing of an insurance claim).

The user may also designate other users (e.g., instructors, trainees, clients, or other individuals involved in an insurance claim) to access any of these stored instruction documents, or the system may determine which individuals to authorize for access. These authorized users may than retrieve, view, and/or trigger a download of these instruction documents, for example, by accessing the virtual file cabinet within the virtual instructional environment.

In various embodiments in which the virtual file cabinet includes insurance-related instruction documents, this access to the virtual file cabinet may enable the authorized users to access those instruction documents and quickly determine coverage in real time in case of an event or other insurance-related event. This may be done as part of the instructional training being provided.

It should be noted that access to the virtual file cabinet may further include access to certain instruction documents included within the virtual file cabinet. In other words, a blanket or broad access may be given to a certain user by the authorized user so that that the broad access user may be able to see and access all instruction documents included within the virtual file cabinet. In another case, a user may be given limited or targeted access to a specific set of instruction documents included in the virtual file cabinet, and that limited access user would only be able to see and access those instruction documents.

The system may further provide for a real time instruction support for a trainee in the virtual instructional environment. The system may provide guidance and/or instructions to the trainee via a trainee computing device, for example, as prompts displayed within the virtual instructional environment and/or instructions provided by an instructor avatar. These prompts may include text or speech (e.g., speech associated with the virtual avatars described above). The prompts may include an instructional recommendation including a script (e.g., a teleprompter) for the trainee to communicate to a client. In another example, the prompts may instruct the trainee to take pictures and/or ask questions to the client. The user computing device may also passively collect data, such as image and/or audio data to generate a historical instructional exercise record which may be used to evaluate the performance of the trainee.

In some embodiments, the collected information during an instructional exercise may be used to determine if additional resources, such as emergency personnel or insurance personnel, need to be contacted, and automatically initiate such contact (e.g., by initiating a virtual and instructional emergency “9-1-1” call and/or presenting an instructor avatar within the virtual instructional environment as described above). The collected information may further be used to generate digital twins, simulations, and/or visual reconstructions of an actual geospatial environment, which may be used to determine an extent of damage or injury that has occurred and the cause of an incident, such as an event, vehicle or otherwise, a hail store, a hurricane, a fire, a flood, etc. In some embodiments, these reconstructions may be viewed within the virtual instructional environment by the trainee, the instructor and/or a client.

### Providing User Interactions in a Virtual Instructional Environment During an Instructional Exercise

In the exemplary embodiment, the instructional computing system may communicate with the user computing device to cause the user computing device to present the VR instructional environment. In certain embodiments described herein, users may refer to any person, or virtual person representation, interacting with the VR instructional environment, such as an instructor, a trainee, and/or a client receiving assistance from the instructor and/or the trainee, during an event. The system may provide video data, audio data, or other data (e.g., haptic feedback data) that may be presented to the user by the user computing device, e.g., presented to the trainee. The system may receive user input data such as live audio data, live video data, or live motion data from the user computing device, and based upon this received user input data, the system may continually update the VR instructional environment. For example, the system may respond to motion, voice commands or other speech, and/or other input (e.g., facial expressions) of the user. In some embodiments, if the system determines that the user is visiting a location within the VR instructional environment based upon the input data, an instructor or other individual associated with the location may receive a notification.

In the exemplary embodiment, the system may generate a proposed response to a user based upon received user input data. User input that indicates a response may be required may include questions input by the user (e.g., as voice or text) or other actions by the user. For example, if the user (e.g., the client or trainee) is not talking but has a confused facial expression, the system may be triggered to determine information or some other assistance (e.g., one or more instructional recommendation) to offered to the trainee (e.g., to guide the trainee in their interaction with the client). The instructional recommendation may include a proposed response including information to provide the trainee (e.g., specific language to speak to the client and/or documents to provide to the client).

In some embodiments, the system may be triggered to generate the instructional recommendation based upon motions or gestures to performed by the instructor avatar, or other actions. Additionally or alternatively, the system may be triggered to generate the instructional recommendation by any satisfied suitable criterion, referred to herein as an instructional incident.

In some embodiments, these instructional recommendations may include actions outside of the VR instructional environment, such as sending emails, phone messages, and/or text messages (e.g., to the trainee or the instructor). In certain embodiments, additional or alternative actions may be executed outside of the VR instructional environment. For example, if the client agrees to a purchase and/or enroll in an insurance policy or program (such as Drive Safe & Save™) within the VR instructional environment, the system may transmit documents for the client to sign or forms for the user to submit payment information as an email and/or web link. In some embodiments, transmission of these documents may be triggered by analogous actions in the VR instructional environment, such as by dropping a document into a virtual mailbox.

In some embodiments, these actions may include real-time binding offers or quotes (e.g., insurance quotes), to which the client may accept within the VR instructional environment. These may be generated based upon data provided by the users within the VR instructional environment and/or other retrieved data about the user (e.g., from a user profile and/or other web sources or databases accessible by the system). Any input from the user may be recorded by the system to enable such transactions to be processed and referred back to in the future.

In certain embodiments, when the instructional computing system generates an instructional recommendation, the system may determine whether an instructor, trainee, or client is present at an instructor, trainee, or client computing device interface (e.g., a computing and/or an VR or AR headset through which the instructor may control a respective avatar). For example, the system may determine whether the instructor, trainee, or client is logged in and/or has made any input through the user interface (e.g., speech, motion, keystrokes, etc.) within a threshold period of time.

When the instructor, trainee, or client is present at the interface of user computing device, the system may cause the instructor, trainee, or client interface to display an instructional recommendation, (e.g., a proposed response or scripted text) that may be read substantially verbatim by the trainee. For example, the instructional recommendation may be displayed as an overlay within the VR instructional environment visible to at least one of the instructor or trainee, although not visible to the client or other users accessing the VR instructional environment. In some embodiments described herein, the instructional recommendation may describe the emotional state of the client, providing the trainee with valuable feedback during interactions with a client and facilitating instruction of conflict resolution.

In these cases, the instructional recommendations may direct either the trainee, or the instructor, on how the trainee should respond to questions, statements, gestures, facial expressions, and/or other actions made by the client. For example, if the system determines the client is becoming confused during an interaction with the trainee, the generated instructional recommendations may direct the trainee to slow down and/or offer additional explanation. These instructional recommendations may be generated using one or more chatbots and/or using AI programs such as ChatGPT. In some embodiments, if the client and trainee speak different languages, the system may provide translation in real time.

In the exemplary embodiment, when the user (e.g., the instructor and/or the client) is not present at the user computing device (e.g., not present at an interface of the user computing device) interface, the instructional computing system causes that at least one avatar associated to perform the proposed actions based upon a replicant persona associated with the instructor and/or the client. In such cases, the avatar may replicate the traits of the instructor or client including, but not limited to, the mannerisms, appearance, personality, historical and conversational talking points. Actions or responses of the replicant persona may be generated using one or more chatbots and/or using AI programs such as ChatGPT. Accordingly, the avatar may act as a user interface for the business when the instructor or client is not present or unavailable, with the avatar interacting with trainee to support instruction exercises (e.g., during early training phases before the trainee is ready to interact with real clients) without being burdensome to the instruction (e.g., the instructor does not need to be actively involved in each instructional exercises).

In some embodiments, for example, the VR instructional environment may present an instructional exercise based upon historical interactions between the trainee and one or more clients, and as such, the VR instructional environment may support an AI generated avatar of an example client, and not a client that is present at the interface. Likewise, the VR instructional environment may support an AI generated avatar of an example instructor, and not an instructor that is currently present at the interface of the instructor computing device.

For instance, a replicant persona for an instructor or other representative for a business and/or a client may be created and stored. When a user (e.g., a trainee), in a virtual reality environment walks into the virtual reality representation of an instructional environment (e.g., a business, a residential location, a classroom, etc.), the trainee may be greeted by an avatar of the instructor that may answer questions or introduce the instructional exercise.

In some embodiments, a new avatar (e.g., each representing the instructor) may be generated to interact with each trainee. These could be multiple instructor avatars each connected to different personas or multiple avatars with the same persona. Therefore, multiple trainees could be interacting with their own version of the avatar of the instructor, simultaneously. This allows the instructional computing system to provide a personal, singular engagement with trainees, enabling trainee interactions with the instructing system to be customized to the trainee, e.g., the historical behavior or prior performance of the trainee during other historical instruction exercises.

In a further example, an instructor avatar generated to interact with a trainee may be trained to interact with the trainee within the metaverse in accordance with certain traits of the instructor learned through virtual or actual interaction with the user. In one example, the traits of the instructor may include the instructor's body language, the instructor's speaking accent and/or dialect observed from an initial interaction (real or virtual) with the instructor for a specific training period (e.g., initial 5 minutes or 10 minutes). Additionally, or alternatively, the traits of the instructor may be retrieved from a database in which the instructor's profile and the traits of the instructor are stored.

In some embodiments, the avatar of the instructor or trainee may be interacting with the client to sell a new product or service (e.g., insurance products) for the client's newly purchased home or vehicle, or the avatar may be interacting with the client for a claim submitted by the client for an event or a loss of a vehicle, or damage to the client's home, vehicle, crops, personal items, and so on. Accordingly, the instructor or client avatar may be trained to show empathy, excitement, joy, kindness, or some other emotion that is appropriate with the cause of the interaction with the trainee. Additionally, or alternatively, certain traits or mannerisms of the avatar representing the instructor or client, which may help to increase the trainee's confidence during instructional exercises. In some cases, those traits or mannerisms incorporated into the avatar may include similar traits and mannerism expressed by the instructor or client.

In some embodiments, the avatar may initially be controlled by a live user, for example, to respond to or greet other user, and/or to interact with other user to provide answers or information to the other users. However, based upon the monitoring of the virtual interaction between the avatar being controlled by the real user, if it is determined that the interaction is not meeting a specific criterion, for example, the real instructor's interactions with the trainee are not generating the desired responses or feedback from the trainee, the avatar may be controlled by an artificial intelligence (AI) model or a machine-learning model to meet the specific criterion. For example, the real instructor may be having a bad day, and, therefore, may be unable to show an appropriate level of empathy towards the trainee during an instructional exercise or the instructor is unable to explain a concept in a clear manner such that either, or both, of the instructor and trainee is becoming frustrated. Upon detecting such a condition or feedback from the trainee or instructor, the system may control the avatar via the AI model or the ML model to adjust the level of empathy and/or reexplain concepts to the trainee. Conversely, if is determined that a computing-controlled avatar is a specific criterion, the system may alert a live instructor to take control of the avatar to assist in an instructional exercise.

In some examples, based upon a user profile of the user or historical interactions with the user, if it is determined that the user has a specific accent or dialect associated with a specific geographic location, the avatar may interact with the other user using the specific accent or dialect. If it is learned that the user frequently uses jokes, or one-liners while interacting, the avatar may be trained to use similar behavior while interacting with the other user, which is likely to increase a comfort level of the other while interacting with a user's avatar.

In addition, using one or more sensors (e.g., a biometric sensor, microphone and/or a camera), the instructor's facial gestures, hand gestures, body language, and so on, may be recorded (e.g., while the instructor is controlling the avatar live) and used for training the avatar to interact with a trainee in a specific way to encourage the trainee to learn during instructional exercises. An artificial intelligence (AI) model or a machine-learning (ML) model may be used to train the avatar to identify which traits of the instructor are beneficial to mimic or reproduce to increase the trainee's trust and confidence, and/or which traits of the instructor may not be used by the avatar.

The AI or ML model may also be used to train the avatar to use empathy during instruction exercises with the instructor avatar. For example, if the trainee is frustrated and/or is confused regarding how to communicate policy information to a client, the instructor avatar may use a kind or slow cadence to explain to the trainee the details of the policy information and how it should be relayed to a client.

The replicant persona, based upon which the avatar may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the instructor. The replicant persona is then used to generate one or more avatars to create unique and personalized experiences for users in a virtual reality or augmented reality space.

Data used to develop this replicant persona may include, but is not limited to, all available interactions from movies, videos, social media posts, interviews, recordings, images, scripts, other sources where a person's (e.g., an instructor's) true personality and style could ultimately be captured, and/or current or previous interactions with the user. These data points could then be synthesized by deep/machine learning and cognitive computing and AI Voice subfields to accurately represent the instructor and how they might respond given certain inputs and scenarios while interacting with the user.

The replicant persona may be used to generate individual avatars for different interactions. In some further embodiments, the individual avatar may be loaded with or have access to information about the individual user that the avatar is interacting with. For example, the avatar may know the user's name and call them by name directly. In a business interaction, the avatar may know additional information about the user, up to and including account details and/or other private or personally identifiable information.

In some embodiments, where the person (e.g., instructor) to be represented by the avatar is available, the system may use a 3-D indexing tool to scan the instructor. The 3-D indexing tool may scan and capture the physical essence of the instructor including, but not limited to physical attributes, tattoos, hair style, make-up, clothing, and other interesting aspects of the instructor to use with an avatar that interacts with the user.

In some examples, a user may use his/her user avatar to interact with the virtual reality environment, including interacting with other user avatars in the environment. While a user avatar represents the individual user on a one-to-one basis, a replicant persona can have multiple avatars executing simultaneously in different areas of the virtual reality. For example, a first user may be in a virtual room with a first avatar of the replicant persona, while a second user is in a separate virtual room with a second avatar of the same replicant persona. The first user and the second user may be able to separately and simultaneously interact with their own avatar of the replicant person.

The use of Virtual Reality (VR) and Augmented Reality (AR) for interacting with 3D avatars provides a new interface for interacting in new ways. VR and AR systems allow a user to interact with a 3D virtual instructional environment in a new way compared to traditional interactions using a two-dimensional (2-D) display. In VR, a user may be immersed in a virtual instructional environment (e.g., using a VR headset). In other words, a VR device displays images, sounds, etc. to the user in a way that mimics how a user receives sensory stimuli in the real world. In AR, the user may be provided with digital data that overlays objects or environments in the real world (such as via AR glasses). AR devices may use a camera or other input to determine the objects in a user's line of sight and present additional digital data that compliments the real-world environment.

Examples of VR instructional environments may include, but are not limited to, Minecraft® (Minecraft is a registered trademark of Microsoft Corporation, Redmond, Washington), Metaverse, and Second Life® (Second Life is a registered trademark of Linden Lab of San Francisco, CA). These VR instructional environments allow the user to interact with and modify said environments using VR tools, such as by building and creating content including structures and objects.

As described in further detail herein, VR and AR technologies may be utilized to more effectively interact with avatars, such as described herein. In one embodiment, a user interacts with an avatar using VR. Specifically, the user navigates a virtual instructional environment, applying bounding frames to objects, labeling objects, rotating views, and traversing areas of the virtual instructional environment using a VR device. The user also may interact with individual avatars in the virtual instructional environment. These avatars may be other users with their user avatars or avatars controlled by replicant personas as described herein. In other words, the user may be immersed in a virtual instructional environment and interact with the virtual instructional environment through the VR device in order to interact with and/or view 3D objects and avatars. In one embodiment, the virtual instructional environment may be a recreation and/or representation of a place of business and the user may interact with avatars in the place of business to conduct transactions with the business.

In another embodiment, a user may view a real-world environment, and an AR device may display virtual content overlaying the real-world environment. Specifically, if the user is in a geographic location associated with the geographic location of an avatar, the AR device may overlay the real-world environment with the avatar from the 3D digital environment, allowing the user to interact with the digital environment and digital objects. For example, the user may be in a place of business, and the user may receive information about the business or its products as an overlay.

### Providing Secure Data Exchange in a Virtual Instructional Environment

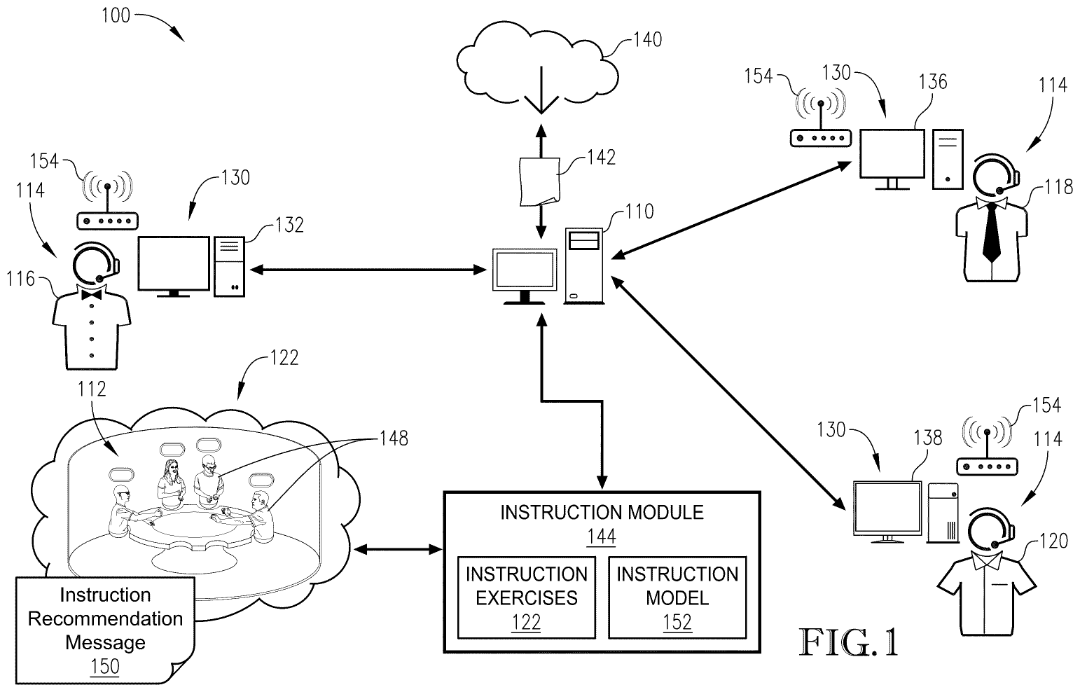

In various embodiments described herein and as shown in FIG. 1, the instruction exercises 122 conducted by trainee 116 may include AI generated or pre-saved instruction exercises 122 and the client avatar 148 is AI generated, e.g., during initial instruction phases before the trainee 116 is skilled enough to interact with actual clients 120. However, some instruction exercises 122 may be conducted with actual clients 120, while enabling supervision with the instructor 118 and/or the instructional support provided by the instructional system 100. As such, the instructional system 100 may also be enabled to provide real-time support for actual clients 120 including secure or encrypted exchange of sensitive client data. For example, in the exemplary embodiment, the system 100 may provide a secure exchange of instruction documents and/or other data using a virtual file cabinet mechanism.

The virtual file cabinet may enable a user 114 to securely store instruction documents and to authorize other users to access the instruction documents. For example, the instructor 118 may, through input (e.g., within the virtual instructional environment, a mobile app, and/or web page) designate instruction documents (e.g., instruction recommendation messages 150, scripts, sensor data, insurance policy documents, insurance cards, and/or documents and/or other data relating to the instruction exercise 122 and/or to insurance claims) to be stored in the virtual file cabinet, or the instruction documents may automatically be stored in association with the virtual file cabinet in response to certain events (e.g., triggering of an instruction evaluation, purchase or renewal of an insurance policy and/or filing of an insurance claim).

The user 114 may also designate other users 114 (e.g., instructors 118, trainees 116, clients 120, other individuals involved in an insurance claim) to access any of these stored instruction documents, or the system 100 may determine which individuals to authorize access to certain instruction documents stored within the virtual file cabinet. These authorized users may than retrieve, view, and/or trigger a download of these instruction documents, for example, by accessing the virtual file cabinet within the virtual instructional environment. In embodiments in which the virtual file cabinet includes insurance-related instruction documents, such access enables authorized users 114 to quickly access these instruction documents and determine insurance coverage in real time in case of an event or other insurance-related event.

In the exemplary embodiment, the system 100 may be configured to communicate with one or more user computing devices 130 to cause those user computing devices 130 to present the virtual instructional environment to include at least one virtual file cabinet associated with a first user. In some embodiments, the virtual file cabinet may appear similar to an actual file cabinet or any other item (e.g., a safe or a file cabinet) users would likely understand to indicate a secure place to store instruction documents. Alternatively, the virtual file cabinet may appear as any other type of item, point, or node within the virtual instructional environment labeled as such (e.g., an icon or button). As described above, each user may have a corresponding user avatar, which may interact with the virtual file cabinet within the virtual instructional environment analogously to how a person may interact with a file cabinet in real life (e.g., opening or closing and/or depositing or withdrawing instruction documents).

As described in further detail below, access to and/or the appearance of the file cabinet to a particular user may be controlled based upon whether the particular user is authorized to access any instruction documents stored in the virtual file cabinet. Within the virtual instructional environment, the virtual file cabinet may include and/or be labeled with text or indicators providing information about the virtual file cabinet (e.g., which user is associated with the file cabinet, a relationship between the viewer and the user is associated with the file cabinet, and/or whether the viewer has access to any instruction documents in the virtual file cabinet). For example, the file cabinet may include a lock that requires a combination or code to be entered to allow a user to access instruction documents included within the file cabinet. A different code may be tied to the different instruction documents included with in the virtual file cabinet such that when a code is entered only the instruction documents linked to that code are shown and are accessible by that user.

In the exemplary embodiment, the system may be configured to store one or more instruction documents in the memory in association with the virtual file cabinet. For example, the user may designate instruction documents to store in association with the virtual file cabinet or the system may automatically determine and store, or suggest storing, instruction documents in association with the virtual file cabinet. In some embodiments, the user may input instructions at a mobile device via a mobile application instruction(s) to store instruction documents in associated with the at least one virtual file cabinet. The system may then store the one or more instruction documents in association with the at least one virtual file cabinet in response to receiving the instruction.

In some embodiments, the user may generate user input data (e.g., by making corresponding movements and gestures) with the user computing device that indicates an intention to store the one or more instruction documents in association with the virtual file cabinet (e.g., dragging and placing, or selecting from a menu). The system may then store the one or more instruction documents in association with the virtual file cabinet in response to receiving this user input data.

In some embodiments, the system may automatically identify instruction documents to store. For example, the system may identify any insurance policy instruction document, insurance cards, and/or insurance claim instruction documents that are associated with the user, and may automatically store the instruction documents or generate instruction recommendations for the user to store the instruction documents in the virtual file cabinet.

In the exemplary embodiment, the system may be configured to identify one or more authorized users of the plurality of users to enable access to the at least one virtual file cabinet. In some embodiments, the user associated with the file cabinet may select other users to receive authorization. For example, the user may submit instructions at the mobile device via the mobile application instructions to designate one or more users as authorized to access the one or more instruction documents, and the system may identify one or more authorized users based upon the received instruction. The user may submit similar instructions through another channel, such as through interaction within the virtual instructional environment itself and/or through another computing device.

In some embodiments, the system may automatically determine who should have access to the virtual lock box. For example, the system may identify any instructors associated with the user and/or any other individuals involved in claims submitted by the user (e.g., other parties of an event, other insurers, police officers, repair technicians, etc.) as authorized to access one or more of the instruction documents stored in association with the virtual file cabinet.

In the exemplary embodiment, the system may be configured to provide access to the one or more instruction documents in response to the identified one or more authorized users interacting with the virtual file cabinet in the virtual instructional environment. For example, the authorized users may open, click, or tap on, or otherwise interact with the virtual file cabinet in the virtual instructional environment, which may enable the authorized users to view of download the instruction documents. In some embodiments, the instruction documents may be viewed within the virtual instructional environment. Additionally, or alternatively, accessing the instruction documents in the virtual instructional environment may trigger a download or other transfer of data that enables the instruction documents to be viewed through a different channel, such as through the mobile app, web page, and/or another type of file-viewing application.

### Providing Real-Time Instructional Support to Trainees Interacting With Clients in Virtual Environment

In the exemplary embodiment, the system may provide for a real time instruction support for the trainee interacting with client within the virtual instructional environment. The system may receive sensor data from the user computing devices (e.g., data captured by smart glasses or biometric devices), which may be used to determine if an event (e.g., a vehicular collision, hail or weather event, hurricane, flood, fire, or other incident resulting in injury and/or property damage) has occurred. In response to detecting an event and/or receiving input from the user (e.g., as a voice command) that an event has occurred, the system may prompt the user to interact with a live instructor and/or replicant persona in the virtual instructional environment as described above.

The system may provide guidance and/or instructions to the user via the user computing device, for example, as prompts displayed within the virtual instructional environment and/or instructions provided by an instructor avatar. These prompts may include text or speech (e.g., speech associated with the virtual avatars described above). The prompts may include questions verifying that the user is not injured or to provide information about what has occurred. For example, the prompts may instruct the user to take pictures and/or ask questions to others present at the scene of the event.

The user computing device may also, with the user's permission or consent, passively collect data, such as image and/or audio data, in response to the event being detected. This collected information may be used to determine if additional resources, such as emergency personnel or insurance personnel, need to be contacted, and automatically initiate such contact (e.g., by initiating an emergency “9-1-1” call and/or presenting an instructor avatar within the virtual instructional environment as described above). The collected information may further be used to generate digital twins, simulations, and/or visual reconstructions of the event, which may be used to determine an extent of damage or injury that has occurred and the cause of the event, such vehicle component or system malfunction to properly assign fault. In some embodiments, these reconstructions may be viewed within the virtual instructional environment.

In the exemplary embodiment, the system may be configured to receive sensor data from the user computing devices. For example, at least some of the user computing device may include cameras, microphones, motion sensors (e.g., accelerometers and/or gyroscopes), location sensors (e.g., GPS), radar, and/or lidar. User computing devices 130 may also include biometric sensors, including for example and without limitation, heart rate sensors, oxygen, or CO2 sensors, a stress sensor (e.g., continuous electrodermal activity (cEDA) sensors), temperature sensors, blood pressure sensors, and/or sweat sensor (e.g., epidermal optic sensors). The user computing devices may include any other types of sensors. This data may be received (e.g., continuously, or periodically) prior to, during, and following an event. As described in further detail below, this senor data may be used by the system to determine when an event has occurred and to gather information about the nature, scene, context, and results of the event.

In the exemplary embodiment, the system may be further configured to determine, based upon the received sensor data, that an event has occurred. In some embodiments, this determination may be made by analyzing audio, video, and/or motion data, for example, using AI and/or machine learning techniques and/or by comparing such data to one or more predefined thresholds indicative that an event has occurred (e.g., a vehicle decelerating more quickly that would be possible using the brakes).

In some embodiments, the determination may be made based upon detected voice, speech, facial expressions, and/or gestures made by the user or other individuals in the area. For example, in some embodiments, the system may utilize specific voice commands or phrases made by the user (e.g., saying “in an event”) to determine an event has occurred and initiate an appropriate response. Additionally, or alternatively, the system may analyze non-structured speech or voice (e.g., using AI and/or chatbots) to determine that the non-structured speech or voice indicates an event has occurred. When it is determined an event has occurred, the user may be alerted to launch or access the virtual instructional environment via the user computing device using voice commands.

In some embodiments, the system may be configured to detect one or more voice commands input by the first user to the first user computing device. As described above, some of these voice commands may relate to an indication that an event has occurred. Additionally, the voice commands may request specific actions, such as contacting an instructor (e.g., by saying “contact my instructor”) or calling emergency services (e.g., by saying “call 9-1-1”).

The system may analyze these voice commands (e.g., using AI and/or chatbots and/or by performing a lookup based upon the received speech) to determine an appropriate response. For example, saying “contact my instructor” may bring the instructor, instructor staff, instructor machine learning bot/avatar or replicant persona, or claim representative into the metaverse channel for discussion or other interaction with the user. Additionally or alternatively, the system may present within the virtual instructional environment to an instructor using an instructor device of the user computing devices 130, a prompt to communicate with the user within the virtual instructional environment.

As described above, the system may generate responses to be performed by avatars and/or recommended to live instructors and/or other instructor personnel, and may retrieve relevant policy documents for review by the instructor. In some embodiments, the system may determine to perform these actions (e.g., contacting emergency personnel) even without a specific voice command. For example, if the system determines a sufficiently severe event has occurred, the system may automatically contact emergency personnel through an appropriate channel to request assistance and/or provide relevant information (e.g., a location of the event and/or identities of persons involved).

In the exemplary embodiment, in response to determining the event has occurred, the system may be configured to present within the virtual instructional environment one or more prompts for collecting information relating to the event using the user computing device. The prompts may be presented as text, audible commands, and/or statements made by avatars within the virtual instructional environment. Examples of such prompts may include instructions to take pictures of the event scene and where and/or questions to ask others at the scene of the event.

In some embodiments, these prompts may be generated using AI and/or chatbot technology, for example, to gather as much information as possible relevant to completing an insurance claim. The system may record interactions or other information resulting from the user following these instructions. This information, such as the captured pictures and/or statements made by others at the scene of the event (e.g., witness accounts of what happened, statements indicating what happened, contact information, etc.), may be transmitted by the user computing device back to the system to be recorded and/or analyzed further.

In some embodiments, the system may automatically identify other individuals at the scene of the event. For example, the system may detect one or devices proximate to the user computing device (e.g., using Bluetooth device identification and/or another appropriate form of wireless communication), and may perform a lookup to identify individuals present at a scene of the event based upon the detected one or more devices. In some embodiments, the system may identify individuals based upon detecting and analyzing voices of or statements made by the individuals detected by the user computing device.

In the exemplary embodiment, the system may be further configured to generate an event profile including the information collected by the user using the first user computing device in response to the one or more prompts. The event profile may be a database, database component, and/or data structure that stores various types of information associated with the event. In addition to the sensor data and information gathered by the user associated with the event, other relevant data may be recorded in association with the event profile, such as a date, time, location, weather, traffic, maps, geographic models, or vehicle models, and/or other data associated with or providing context to the event. In some embodiments, the system may retrieve additional documents, such as a police report, insurance policy documents, insurance claim documents, and/or estimates or receipts from mechanics associated with the event and store these documents in association with the event profile.

In some embodiments, the system may generate one or more digital twins representing people, vehicles, or other objects involved in the event and/or a visual representation and/or reconstruction of the event based upon information included in the event profile. For example, the system may parse the event profile for sensor data, speech data, and/or documents relating to the event to identify positions and orientations of relevant people and objects during the course of the event. In some embodiments, AI and/or machine learning techniques may be utilized for such parsing. In some embodiments, the system the visual representation may be presented within the virtual instructional environment, so that instructors or others reviewing the event may do so in a three-dimensional environment.

At least one of the technical problems addressed by this system may include: (i) improving interactions in a virtual reality environment by detecting and mimicking certain mannerisms and personality traits of a user, e.g., a trainee, an instructor, and/or a client, including the emotions of the user and the subject matter of the conversation during the interaction with the user; (ii) improving accuracy of artificial intelligence driven avatars in virtual reality; (iii) improving a trainee instruction process using instruction interactions with AI driven avatars; (iv) providing access to a trainee for remote interactions with instructors or clients, in a virtual environment simulating a face-to-face interaction; (v) facilitating an exchange of information through a virtual instructional environment by enabling recording interactions within the environment and triggering exchange of information through different channels in response to interactions within the virtual instructional environment; (vi) improving interactions within a virtual instructional environment by providing supplemental instruction recommendations for responding to a client while considering the clients emotional state, e.g., using biometric parameters such as heart rate, gestures, body language, and facial expressions; (vii) providing an ability to securely transfer instruction documents and/or other data in a metaverse environment; (viii) providing instruction assistance and/or a script to be communicated in real-time during current interactions between trainees and clients; and/or (ix) providing trainee with information regarding the emotional state of the client to facilitate instruction of conflict resolution techniques.

The computing-based or computer-implemented methods and computing systems described herein may be implemented (i) using computing programming or engineering techniques including computing software, firmware, hardware, or any combination or subset thereof, and/or (ii) by using one or more local or remote processors, transceivers, servers, sensors, servers, scanners, AR or VR headsets or glasses, smart glasses, wearables, smart watches, dermal patches, mobile devices, laptops, video game systems, and/or other electrical or electronic components, wherein the technical effects may be achieved by performing at least one of the following action or operations: i) communicating with the one or more trainee computing devices each associated with a trainee to cause the one or more trainee computing devices to present the virtual instructional environment, wherein the virtual instructional environment is associated with an instructional exercise, the virtual instructional environment includes a client avatar representing a client for interactions with the trainee; ii) receiving sensor data from at least one of the trainee computing device associated with the trainee and a client computing device associated with the client during a current virtual interaction between the trainee and the client; iii) evaluating the current interaction between the trainee and the client by applying the received sensor data associated with the current interaction to a trained instructional recommendation model to generate one or more outputs including an instructional recommendation message including a scripted text for the trainee to communicate during the current interaction; and/or iv) presenting, within the virtual instructional environment, to the trainee user computing device, the instruction message.

### Exemplary Employee Instructional Computing System

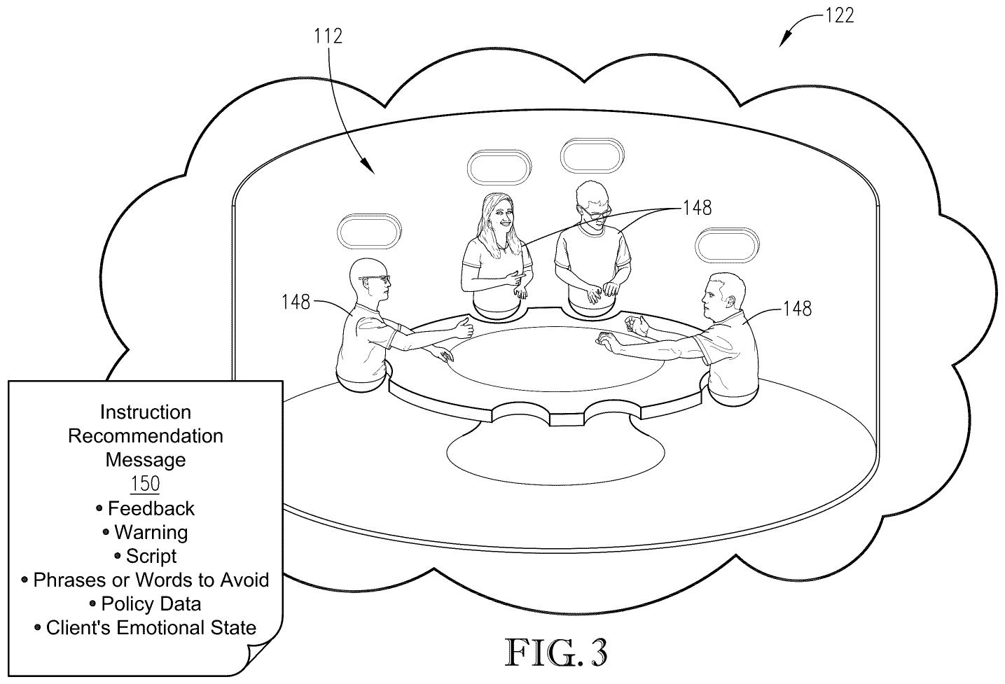

FIG. 1 depicts a simplified schematic diagram of an instructional system 100 including an instructional computing system 110 for supporting virtual reality (VR) instructional environments 112, shown and described in greater detail in FIG. 3, enabling interactions between one or more users 114 within the VR instructional environment 112. For example, the VR instructional environment 112 enables a trainee 116 (e.g., a newly hired employee) to interact with an instructor 118 (e.g., a senior associate tasked with training the newly hired employee) and/or a client 120 (e.g., an insured person or person requesting information or assistance during an event, such as policy information, refunds/premium amounts, etc.) during one or more instruction exercises 122 including the VR instructional environment 112.

The instruction computing system 110 is communicatively coupled to one or more additional user computing devices 130 associated with the one or more users 114, e.g., a trainee computing device 132 associated with the trainee 116, an instructor computing device 136 associated with the instructor 118, and a client computing device 138 associated with the client 120. The instructional computing system 110 is communicatively coupled to a database 140, e.g., a cloud-based storage device, which may store historical records 142, such as recorded historical instruction exercises 122, any historical interaction between a historical trainee 116 and historical instructor 118, and/or historical client interactions. The instructional system 100 further includes an instruction module 144 for generating one or more instruction exercises 122, e.g., including one or more VR instructional environments 112, one or more avatars 148 representing one or more users 114, and/or one or more instruction recommendation message 150, described below, which may be presented, e.g., within the instructional virtual environment 112, to the trainee 116 and/or the instructor 118 during an instruction exercise 122.

In embodiments described herein, the instructional system 100 may support a plurality of different instruction exercises 122 including a plurality of different VR instructional environments 112 and/or a plurality of different users 114, e.g., avatars 148 of different clients 120. For example, and without limitation, the instructional system 100 may generate the VR instructional environment 112 including an office space, representative of an actual or simulated office, a conference space, and/or a workspace associated with the instructor 118 and/or the trainee 116. The VR instructional environment 112 may include a representation of an actual, or simulated, residential property, e.g., an interior of a home, a neighborhood including one or more residential properties and surrounding structures or objects, e.g., trees, houses, roads, etc. In the illustrated embodiment, the VR instructional environment 112 is embodied as an interior room of a residential home associated with the client 120.

The instruction module 144 includes an instruction model 152, e.g., a machine learning or artificial intelligence based, that may be trained using historical records 142. One or more inputs may be applied to the instruction model 152 and the instruction model 152 may generate one or more outputs. For example, the instruction model 152 may be used to generate one or more outputs including instruction exercises 122, e.g., generating the VR instructional environment 112 and/or one or more avatars 148, enabling the trainee 116 to interact with the avatars 148 within the VR training environment 112. The instruction model 152 may also be used to generate the one or more instruction recommendation message 150. In some embodiments, the instruction module 144 may store and/or retrieve from the database 140, one or more pre-generated instruction exercises 122, e.g., suitable for various skill levels of the trainee 116. In certain embodiments, the instruction module 144, and/or the instructor 118, may select an instruction exercise 122 from pre-generated instruction exercises 122 to be completed by the trainee 116.

In some embodiments, the instruction model 152 may generate one or more trainee specific or customized instruction exercise 122 that is tailored to the prior behavior or performance of the trainee 116. In certain embodiments, the instruction model 152 may be re-trained using historical records 142 associated with the trainee 116, e.g., during prior participation of the trainee 116 in historical instruction exercises 122. Additionally, or alternatively, the historical records 142 associated with the trainee 116 may be applied as an input to the trained instruction model 152.

In some embodiments, the instructor 118 may provide trainee 116 specific feedback regarding the performance of the trainee 116 during an instruction exercise and the feedback may be used to re-train the instruction model using the feedback and/or the feedback may be applied as an input to the instruction model. For example, during a historical instruction exercise, the trainee 116 may have difficultly relaying information regarding flood insurance, and as such, based upon instructor 118 feedback and/or the model's 152 evaluation of the trainee's 116 performance during the historical instruction exercise 122, the instruction module 144, e.g., using the instruction model 152, may generate a new, trainee specific instruction exercise 122 associated with a flood.

In some embodiments, the instruction module 144 may generate a plurality of pre-generated instruction exercises 122 having various levels of difficulty. For example, each of the pre-generated instruction exercises 122 may be scored based upon difficulty. A lower score may be associated with reduced difficulty. For instance, a low score pre-generated instruction exercise 122 may be associated with minor hail damage and the VR training environment 112 includes an exterior of residential homes with views of damages to a roof and/or siding. A high score pre-generated instruction exercise 122 may be associated with a total loss cause by a flood and the VR training environment 112 includes an interior of a residential home with views of the flood damaged basement of the residential home. The instruction module 144 and/or the instructor 118 may select a pre-generated instruction exercise based upon prior performance of the trainee 116.

In some embodiments, the pre-generated instruction exercises 122 may be generated based upon a prior historical event, e.g., a historical loss and/or a historical client 120. In certain embodiments, the instruction model 152 generates an instruction exercise 122 that is based upon a plurality of historical losses and/or historical clients 120. In some embodiments, the instruction module 144, and/or the instruction model 152, may generate pre-generated instruction exercises 122 based upon selected criteria, e.g., selected by the instructor 118 or the trainee 116. Selected criteria may include, for example and without limitation, various types of losses (e.g., hail, fire, flood), various levels of loss (e.g., partial loss, total loss, covered losses, and/or uncovered losses), types and/or number of clients 120 (e.g., client demographics, such as age, occupation, residential location, native language, etc.)

Each of the instructor 118, the trainee 116, and the client 120 may be represented within the VR instructional environment 112 as an avatar 148. In some embodiments, the avatar 148 represents an actual user 114, either while the user 114 is actively interacting with the system 100, e.g., in real-time while one or more sensors 154 of the user computing devices 130 is collecting data associated with the user 114, or alternatively, while the user 114 is not actively interacting with the system 100, e.g., the avatar 148 has been trained to represent the users 114 based upon the previous behavior, statements or phrases, and/or mannerisms of the user 114. For example, the trainee 116 may interact with the system 100 to conduct instruction exercises 122 while the instructor 118 is not necessarily interacting with the system 100, e.g., conserving employee resources. During an initial training phase, the trainee 116 may interact with an avatar 148 representing an instructor 118 who is not currently interacting with the system, and then during a subsequent advanced training phase, the trainee 116 may interact with an avatar 148 representing an instructor 118 who is currently interacting with the system 100, enabling the instructor 118 to provide actual feedback in real-time.

In some alternative embodiments, the avatar 148 may not necessarily represent a singular actual user 114, rather, the avatar 148 is trained to represent a plurality of different users 114. For example, the client avatar 148 may be an artificially generated client 120 (referred to herein as an AI generated avatar 148), e.g., the avatar 148 does not represent of an actual historical client 120, but rather a plurality of different historical clients 120. The artificially generated client avatar 148 may be particularly useful for instructing the trainee 116 during an initial training phase, e.g., before the trainee 116 is ready to interact with an actual or virtual representation of an actual client 120. Subsequently, during an advanced training phase, the avatar 148 may represent an actual client 120 currently interacting with the system 100 during a current event, e.g., in real-time while one or more sensors of the client computing device 138 is collecting data associated with the client 120. In some embodiments, the system 100 may generate various versions of the avatar 148 representing various simulated clients 120 to improve or facilitate the instruction exercises 122.

The different types of client avatars 148 enable the instructional system 100 to provide various instruction exercises 122 with various types of clients 120 for instructing a trainee 116 to handle various personality types. For example, during early instruction phases, e.g., when a trainee 116 is a novice, the instructional system 100 may deploy instruction exercises 122 with AI simulated clients 120 having calm emotional states to build the confidence of the trainee 116. Subsequently, the trainee 116 may graduate to instruction exercises 122 that involve an actual client 120 that is currently interacting with the instructional system 100.

The trainee 116 computing device 132 may display the VR instructional environment 112 and the avatars 148, e.g., the avatar 148 of the client 120, the avatar 148 of the instructor 118, and/or the avatar 148 of the trainee 116, within the VR instructional environment 112. Each of the user computing devices 130 may display the VR instructional environment 112 and/or one or more of the avatars 148. In the illustrated embodiment, the system 100 may cause the trainee computing device 132 and/or the instructor computing device 136 to display one or more instructions recommendation messages 150. In some embodiments, the instruction recommendation message 150 is not displayed on the client computing device 138.

In embodiments described herein, the instruction recommendation message 150 may be generated by the instructor 118 and/or a training model 152 trained using historical records 142. The instruction recommendation message 150 may include communication, e.g., text and/or audio, for directing and/or providing feedback to the trainee 116. The communication may prompt the trainee 116 to adjust their behavior, e.g., suggesting that the trainee 116 uncross their arms, to smile, and/or decrease the volume of their voice, etc.

In some embodiments, the instruction recommendation message 150 may prompt the trainee 116 to avoid using certain terms or phrases, e.g., avoid using harsh or unsympathetic phrases. In various embodiments, the instruction recommendation message 150 may present information, e.g., claim details, policy details, costs of items, etc., that the trainee 116 may relay to the client 120.

In some embodiments, the instruction recommendation message 150 includes statements or phrases that the trainee 116 should relay to the client 120, e.g., the trainee 116 may read the statements substantially verbatim, to the client 120. In certain embodiments, the instruction recommendation message 150 includes a description of the emotional state of the client 120, e.g., an indication that the client 120 is frustrated, confused, saddened, etc. In some embodiments, instruction recommendation message 150 is generated by the model 152, then transmitted to the instructor computing device 136 where the instruction recommendation message 150 is reviewed or edited, before the communication is subsequently transferred to the trainee computing device 132 for being displayed to the trainee 116.

In embodiments described herein, the instruction module 144 may include a plurality of different instruction models 152 each trained using different training dataset. For example, the instruction model 152 may include an instruction exercise model that is trained to generate the instruction exercises 122 including a virtual instructional environment 112 and one or more avatars 148, e.g., client avatars 148 and/or instructor avatars 148. The instruction module 144 may also include an avatar model that is trained to generate the avatar, e.g., a client 120 or an instructor 118, based upon historical interactions between users 114. The instruction module 144 may include an instruction recommendation model that is trained to generate the instruction recommendation message 150, in real-time, during a current interaction and/or during a current instruction exercise 122. In some embodiments, the instruction model 152 is a single or individual model, and inputs may be applied, e.g., in one instance, to generate a plurality of outputs including one or more instruction exercises 122, one or more avatars 148, and/or one or more instruction recommendation.

In some embodiments, a current interaction and/or a current instruction exercise 122, e.g., during a period of time immediately prior, may be applied to the instruction model 152, to generate the one or more instruction recommendation message 150 that may be presented to the trainee 116 in real time during the current interaction. Generating the instruction recommendation message 150 may be triggered by a question, a statement or request, and/or an expression and/or body language of at least one of the client 120 and/or the trainee 116, generally referred to herein as an instruction incident. In some embodiments, triggering of generation of the supplemental instruction recommendation may be triggered by the trainee 116, e.g., the trainee 116 may transmit one or more messages with instructional system 100, e.g., requesting assistance. As such, the instructional system 100 provides support for a trainee 116 during an instruction exercise to guide the trainee 116 through interpersonal interaction with a client 120 based upon evaluating instruction incidents.

### Exemplary Computing Network

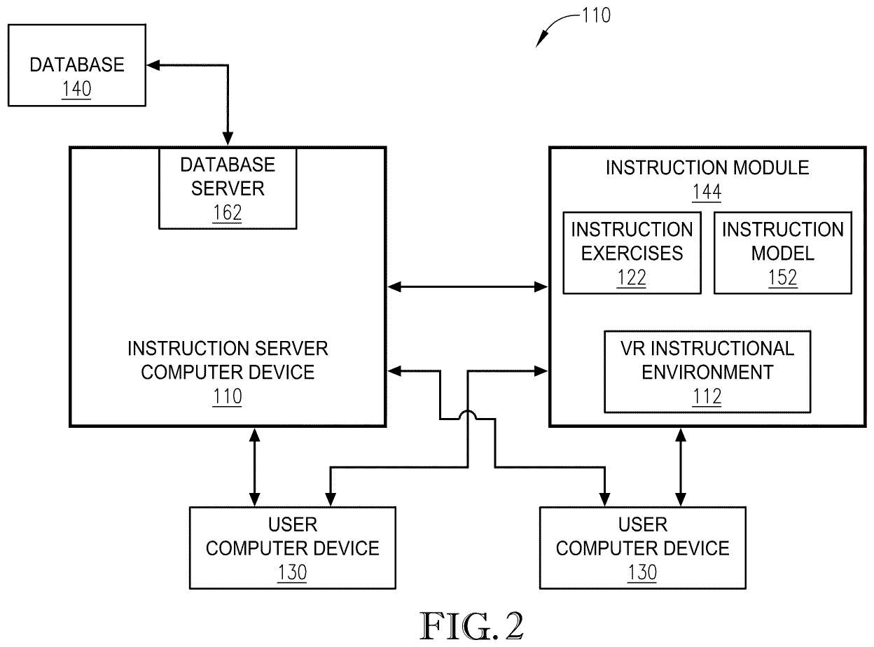

FIG. 2 depicts a simplified block diagram of the exemplary instructional computing system 110 for use with the instructional system 100, shown in FIG. 1. Aspects of FIGS. 1 and 2 are discussed herein. The computing device 110 may provide the VR instructional environment 112 enabling the trainee 116 to interact with a live or virtual instructor 118 and/or a live or virtual client 120.

In the exemplary embodiment, user computing devices 130 are computing devices that include a web browser or a software application, which enables user computing devices 130 to communicate with the instructional computing system 110 using the Internet. More specifically, user computing devices 130 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 130 may include the user computing device 130 and/or interface of user computing device, described herein.

User computing devices 130 may be a device capable of accessing the Internet including, but not limited to, a mobile device, a desktop computing, a laptop computing, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, chat bots, or other web-based connectable equipment or mobile devices. In some embodiments, user computing devices 130 are capable of accessing VR instructional environments 112, such as through instruction modules 144.

A database server 162 may be communicatively coupled to a database 140 that stores data. In one embodiment, database 140 may include scan files, replicant personas, digital twins, VR instructional environments 112, business information, user 114 information, and/or user 114 preferences. In the exemplary embodiment, database 140 may be stored remotely from instructional computing system 110 and/or instruction module 144. In some embodiments, database 140 may be decentralized. In the exemplary embodiment, a user 114 may access database 140 via user computing devices 130 by logging onto the system 100, e.g., by transmitting communication message to the instructional computing system 110 and/or instruction module 144, as described herein.

Instructional computing system 110 may be communicatively coupled with one or more the user computing devices 130. In some embodiments, instructional computing system 110 may be associated with, or is part of a computing network associated with business, or in communication with the business' computing network (not shown). In other embodiments, instructional computing system 110 may be associated with a third party and is merely in communication with the business' computing network. In some of these embodiments, instructional computing system 110 is associated with the instruction module 144.

One or more instruction modules 144 may be communicatively coupled with instructional computing system 110. The one or more instruction modules 144 each may be associated with a VR instructional environment 112. Instruction modules 144 may provide tools and/or applications for users 114 to access their associated VR instructional environments 112 over the Internet. For the purposes of this discussion, VR instructional environments 112 provide immersive environments that simulates how a user 114 receives stimuli in the real world.

In one example, virtual reality (VR) goggles allow a user 114 to see a virtual world. The VR goggles determines when the user 114 turns their head and then renders imaging of what is where the user 114 is looking. Furthermore, the user 114 may use input tools, such as controllers to interact with the environment displayed by the goggles. A user 114 may then interact with digital objects or avatars 148 that have been added to the VR instructional environment 112.

In some embodiments, VR instructional environments 112 simulate parts or portions of the real-world and allow user 114s 114 to own and alter locations in the VR instructional environments 112. For example, a user 114 may own a plot of virtual land and build a version of their real-world house on that plot of land. Or a business could build an office or shop to allow users 114 to interact with the replicant persona avatars 148 in that office or shop.

In the exemplary embodiment, instructional computing system 110 and/or instruction module 144 may communicate with a user computing device (e.g., computing device user computing device 130) to cause the user computing device 130 to present VR instructional environment 112. Instructional computing system 110 and/or instruction module 144 may provide video data, audio data, or other data (e.g., haptic feedback data) that may be presented to the user 114 by the user computing device 130. Instructional computing system 110 and/or instruction module 144 may receive user input data such as live audio data, live video data, or live motion data from the user computing device 130, and based upon this received user input data, instructional computing system 110 and/or instruction module 144 may continually update the VR instructional environment 112. For example, the system may respond to motion, voice commands or other speech, and/or other input (e.g., facial expressions) of the user 114. In some embodiments, if instructional computing system 110 and/or instruction module 144 determines that the user 114 is visiting a location within the VR instructional environment 112 based upon the input data, an instructor 118 or other individual associated with the location may receive a notification.

In the exemplary embodiment, instructional computing system 110 may generate a proposed response to a user 114 based upon received user input data. User input that indicates a response may be required may include questions input by the user 114 (e.g., as voice or text) or other actions by the user 114. For example, if the user 114 is not talking but has a confused facial expression, instructional computing system 110 may determine that information or some other assistance should be offered to the user 114. The proposed response may include information to provide the user 114 (e.g., specific language to speak to the user 114 and/or documents to provide to the user 114), motions or gestures to performed by the trainee 116 or other actions.

In some embodiments, these responses may include actions outside of the VR instructional environment 112, such as sending emails, phone messages, and/or text messages to the user 114. For example, if the user 114 agrees to a purchase within the VR instructional environment 112, instructional computing system 110 may transmit documents for the user 114 to sign or forms for the user 114 to submit payment information as an email and/or web link. In some embodiments, transmission of these documents may be triggered by analogous actions in the VR instructional environment 112, such as by dropping a document into a virtual mailbox. In some embodiments, these responses may include real-time binding offers or quotes (e.g., insurance quotes), to which the user 114 may accept within the VR instructional environment 112. These may be generated based upon data provided by the user 114 within the VR instructional environment 112 and/or other retrieved data about the user 114 (e.g., from a user profile and/or other web sources or databases such as database 140 accessible by instructional computing system 110). Any input from the user 114 or instructor 118 may be recorded by instructional computing system 110 to enable such transactions to be processed and referred back to in the future.

In the exemplary embodiment, when instructional computing system 110 generates a proposed response, instructional computing system 110 may determine whether an instructor 118 is present at an interface of user computing device (e.g., user computing device 130). For example, instructional computing system 110 may determine whether the instructor 118 is logged in and/or has made any input through the user interface (e.g., speech, motion, keystrokes, etc.) within a threshold period of time.

When the trainee 116 or instructor 118 is present at an interface, instructional computing system 110 may cause the interface of user computing device 130 to display an instruction recommendation message including the proposed script or response. For example, the instruction recommendation may be displayed as an overlay within the VR instructional environment 112 visible to the instructor 118 or trainee 116, although not visible to the user 114 or others accessing the VR instructional environment 112.

In these cases, the instruction recommendations may direct the instructor 118 on how to respond to questions, statements, gestures, facial expressions, and/or other actions made by the trainee 116. For example, if instructional computing system 110 determines that the trainee 116 is becoming confused during an interaction with the instructor 118, the generated instruction recommendations may direct the instructor 118 to slow down and/or offer additional explanation. These instruction recommendations, for the instructor 118, may be generated using one or more chatbots and/or using AI programs such as ChatGPT. In some embodiments, if the trainee 116 and instructor 118 or client 120 speak different languages, instructional computing system 110 may provide translation in real time.

In the exemplary embodiment, when the instructor 118 is not present at the interface of user computing device 130, instructional computing system 110 may cause that at least one avatar 148 to perform the proposed response based upon a replicant persona associated with the instructor 118. In such cases, the avatar 148 may replicate the traits of the instructor 118 including, but not limited to, the mannerisms, appearance, personality, historical and conversational talking points. Actions or responses of the replicant persona may be generated using one or more chatbots and/or using AI programs such as ChatGPT. Accordingly, the avatar 148 may act as a user interface for the business when the instructor 118 is not present or unavailable, with the avatar 148 interacting with users 114 to provide information about and to collect information for the business.

For instance, a replicant persona for an instructor 118 or other representative for a business may be created and stored. When a user 114 in a virtual reality environment walks into the virtual reality representation of the business, the user 114 is greeted by an avatar 148 of the instructor 118 that can answer questions and potentially handle the user's request(s). In some embodiments, a new avatar 148 (e.g., each representing the instructor 118) may be generated to interact with each user 114. These could be multiple avatars 148 each connected to different personas or multiple avatars 148 with the same persona. Therefore, multiple users 114 could be interacting with their own version of the avatar 148 of the instructor 118, simultaneously. This allows the business to provide a personal, singular engagement and trainee specific or customized instructors 118 that are best able to provide instruction based upon the learning style of the trainee 116.

In a further example, an avatar 148 generated to interact with users 114 may be trained to interact with the user 114 within the metaverse in accordance with certain traits of the instructor 118 learned through virtual or actual interaction with the user 114. In one example, the traits of the instructor 118 may include the instructor's 118 body language, the instructor's 118 speaking accent and/or dialect observed from an initial interaction (real or virtual) with the instructor 118 for a specific training period (e.g., initial 5 minutes or 10 minutes). Additionally, or alternatively, the traits of the instructor 118 may be retrieved from a database in which the instructor's 118 profile and the traits of the instructor 118 are stored.

In some embodiments, the avatar 148 may be interacting with the user 114 to sell a new product or service (e.g., insurance products) for the user's 114 newly purchased home or vehicle, or the avatar 148 may be interacting with the user 114 for a claim submitted by the user 114 for an event, such as hail or other weather related incident, flood, fire, or damage to the user's 114 home or other assets, vehicle accidents, and so on. Accordingly, the avatar 148 may be trained to show empathy, excitement, joy, kindness, or some other emotion that is appropriate with the cause of the interaction with the user 114. Additionally, or alternatively, certain traits or mannerisms of the avatar 148 representing the instructor 118, which may help to increase the user's 114 confidence and trust in the product and/or service being marketed or sold by the avatar, may be used to train the avatar 148 to incorporate those traits and/or mannerisms into the avatar 148 during interaction with the user 114. In some cases, those traits or mannerisms incorporated into the instructor's 118 avatar 148 may include similar traits and mannerism expressed by the user 114 or the user's avatar 148.

In various embodiments, the avatar 148 may initially be controlled by a live instructor 118, for example, to respond to or greet the user 114, and/or to interact with the user 114 to provide answers or information to the user 114. However, based upon the monitoring of the virtual interaction between the avatar 148 being controlled by the real instructor 118 and the user 114, if it is determined that the interaction is not meeting a specific criterion, for example, the real instructor's 118 interactions with the user 114 are not generating the desired responses or feedback from the user 114, the avatar 148 may be controlled by an artificial intelligence (AI) model or a machine-learning model to meet the specific criterion. For example, the real instructor 118 may be having a bad day, and, therefore, may be unable to show an appropriate level of empathy to the user 114 while interacting with the user 114. Upon detecting such a condition or feedback from the user 114, instructional computing system 110 may control the avatar 148 via the AI model or the ML model to adjust the level of empathy being presented to the user 114. Conversely, if is determined that a computing-controlled avatar 148 is a specific criterion, instructional computing system 110 may alert a live instructor 118 to take control of the avatar.

In some examples, based upon an instructor profile of the instructor 118 or historical interactions with the instructor 118, if it is determined that the instructor 118 has a specific accent or dialect associated with a specific geographic location, the avatar 148 may interact with the user 114 using the specific accent or dialect. If it is learned that the instructor 118 frequently uses jokes, or one-liners while interacting, the avatar 148 may be trained to use similar behavior while interacting with the user 114, which is likely to increase a comfort level of the user 114 while interacting with the instructor's avatar 148.

In addition, using a microphone and/or a camera, the instructor's 118 facial gestures, hand gestures, body language, and so on, may be recorded (e.g., while the instructor 118 is controlling the avatar 148 live) and used for training the avatar 148 to interact with the user 114 in a specific way. An artificial intelligence (AI) model or a machine-learning (ML) model may be used to train the avatar 148 to identify which traits of the instructor 118 are beneficial to mimic or reproduce to increase the user's 114 trust and confidence, and/or which traits of the instructor 118 may not be used by the avatar. The AI or ML model may also be used to train the avatar 148 to use empathy corresponding to the cause of interaction with the avatar. For example, if the user 114 has bought a new home or vehicle and is interacting with the avatar 148 to purchase a new insurance policy, the avatar 148 may use a happy or celebration tone while interacting with the user 114. Similarly, if the user 114 is interacting with the avatar 148 to report a damage or injury claim, the avatar 148 may use a more supportive tone while interacting with the user 114.

The replicant persona, based upon which the avatar 148 may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the instructor 118. The replicant persona is then used to generate one or more avatars 148 to create unique and personalized experiences for users 114 in a virtual reality or augmented reality space, e.g., instructional environment 112.

Data used to develop this replicant persona may include, but is not limited to, all available interactions from movies, videos, social media posts, interviews, recordings, images, scripts, other sources where a user's 112 (e.g., an instructor's 118) true personality and style could ultimately be captured, and/or current or previous interactions with the user 114. These data points could then be synthesized by deep/machine learning and cognitive computing and AI Voice subfields to accurately represent the instructor 118 and how they might respond given certain inputs and scenarios while interacting with the user 114.

The replicant persona can be used to generate individual avatars 148 for different interactions. In some further embodiments, the individual avatar 148 may be loaded with or have access to information about the individual user 114 that the avatar 148 is interacting with. For example, the avatar 148 may know the user's name and call them by name directly. In a business interaction, the avatar 148 may know additional information about the user 114, up to and including account details and/or other private or personally identifiable information.

In some embodiments, where the user 114 (e.g., instructor 118) to be represented by the avatar 148 is available, instructional computing system 110 may use a 3-D indexing tool to scan the instructor 118. The 3-D indexing tool may scan and capture the physical essence of the instructor 118 including, but not limited to physical attributes, tattoos, hair style, make-up, clothing, and other interesting aspects of the instructor 118 to use with an avatar 148 that interacts with the user 114.

In some examples, a user 114 may use his/her user avatar 148 to interact with the virtual reality environment, including interacting with other user avatars 148 in the environment. While a user avatar 148 represents the individual user 114 on a one-to-one basis, a replicant persona can have multiple avatars 148 executing simultaneously in different areas of the virtual reality. For example, a first user 114 may be in a virtual room with a first avatar 148 of the replicant persona, while a second user 114 is in a separate virtual room with a second avatar 148 of the same replicant persona. The first user 114 and the second user 114 are able to separately and simultaneously interact with their own avatar 148 of the replicant user 114.

In the exemplary embodiment, instructional computing system 110 may provide for a secure exchange of documents and/or other data using a virtual file cabinet mechanism. The virtual file cabinet may enable a user 114 to securely store documents and to authorize other users 114 to access the documents. For example, a user 114 may, through input (e.g., within VR instructional environment 112, a mobile app, and/or web page) designate documents (e.g., insurance policy documents, insurance cards, and/or documents and/or other data relating to insurance claims) to be stored in the virtual file cabinet, or the documents may automatically be stored in association with the virtual file cabinet in response to certain events (e.g., purchase or renewal of an insurance policy and/or filing of an insurance claim). The user 114 may also designate other users 114 (e.g., instructors 118, clients 114, or other individuals involved in an insurance claim) to access any of these stored documents, or instructional computing system 110 may determine which individuals to authorize access to certain documents stored within the virtual file cabinet. These authorized users 114 may than retrieve, view, and/or trigger a download of these documents, for example, by accessing the virtual file cabinet within VR instructional environment 112. In embodiments in which the virtual file cabinet includes insurance-related documents, such access enables authorized users 114 to quickly access these documents and determine insurance coverage in real time in case of an event, such as an insurance-related event.

In the exemplary embodiment, instructional computing system 110 may be configured to communicate with one or more user computing devices 130 to cause those user computing devices 130 to present VR instructional environment 112 to include at least one virtual file cabinet for selectively sharing documents between the various users 114. In some embodiments, the virtual file cabinet may appear similar to an actual file cabinet or any other item (e.g., a safe or a file cabinet) users 114 would likely understand to indicate a secure place to store documents. Alternatively, the virtual file cabinet may appear as any other type of item, point, or node within VR instructional environment 112 labeled as such (e.g., an icon or button). As described above, each user 114 may have a corresponding user avatar 148, which may interact with the virtual file cabinet within VR instructional environment 112 analogously to how a user 114 may interact with a file cabinet in real life (e.g., opening or closing and/or depositing or withdrawing documents). As described in further detail below, access to and/or the appearance of the file cabinet to a particular user 114 may be controlled based upon whether the particular user 114 is authorized to access any documents stored in the virtual file cabinet. Within VR instructional environment 112, the virtual file cabinet may include and/or be labeled with text or indicators providing information about the virtual file cabinet (e.g., which user 114 is associated with the file cabinet, a relationship between the viewer and the user 114 is associated with the file cabinet, and/or whether the viewer has access to any documents in the virtual file cabinet). For example, the file cabinet may include a lock that requires a combination or code to be entered to allow a user 114 to access documents included within the file cabinet. A different code may be tied to the different documents included with in the virtual file cabinet such that when a code is entered only the documents linked to that code are shown and are accessible by that user 114.

In the exemplary embodiment, instructional computing system 110 may be configured to store one or more documents in the memory in association with the virtual file cabinet. For example, the user 114 may designate documents to store in association with the virtual file cabinet or instructional computing system 110 may automatically determine and store, or suggest storing, documents in association with the virtual file cabinet. In some embodiments, the user 114 may input instructions at a mobile device via a mobile application to store documents in associated with the at least one virtual file cabinet. Instructional computing system 110 may then store the one or more documents in association with the at least one virtual file cabinet in response to receiving the instruction. In some embodiments, the user 114 may generate user input data (e.g., by making corresponding movements and gestures) with the user computing device 130 that indicates an intention to store the one or more documents in association with the virtual file cabinet (e.g., dragging and placing, or selecting from a menu). Instructional computing system 110 may then store the one or more documents in association with the virtual file cabinet in response to receiving this user input data.

In some embodiments, instructional computing system 110 may automatically identify documents to store. For example, instructional computing system 110 may identify any insurance policy document, insurance cards, and/or insurance claim documents that are associated with the user 114 and may automatically store the documents or generate instruction recommendations for the user 114 to store the documents in the virtual file cabinet.

In the exemplary embodiment, instructional computing system 110 may be configured to identify one or more authorized users 114 of the plurality of users 114 to enable access to the at least one virtual file cabinet. In some embodiments, the user 114 associated with the file cabinet may select other users 114 to receive authorization. For example, the user 114 may submit instructions at the mobile device via the mobile application instructions to designate one or more users 114 as authorized to access the one or more documents, and instructional computing system 110 may identify one or more authorized users 114 based upon the received instruction. The user 114 may submit similar instructions through another channel, such as through interaction within VR instructional environment 112 itself and/or through another computing device. In some embodiments, instructional computing system 110 may automatically determine who should have access to the virtual lock box. For example, instructional computing system 110 may identify any instructors 118 associated with the user 114 and/or any other individuals involved in claims submitted by the user 114 (e.g., other parties of an event, other insurers, police officers, repair technicians, etc.) as authorized to access one or more of the documents stored in association with the virtual file cabinet.

In the exemplary embodiment, instructional computing system 110 may be configured to provide access to the one or more documents in response to the identified one or more authorized users 114 interacting with the virtual file cabinet in VR instructional environment 112. For example, the authorized users 114 may open, click, or tap on, or otherwise interact with the virtual file cabinet in VR instructional environment 112, which may enable the authorized users 114 to view of download the documents. In some embodiments, the documents may be viewed within VR instructional environment 112. Additionally, or alternatively, accessing the documents in VR instructional environment 112 may trigger a download or other transfer of data that enables the documents to be viewed through a different channel, such as through the mobile app, web page, and/or another type of file-viewing application.

In the exemplary embodiment, instructional computing system 110 may provide for a real time instruction support in VR instructional environment 112. Instructional computing system 110 may receive sensor data from the user computing devices 130 (e.g., data captured by smart glasses, biometric sensors, etc.), which may be used to determine if an event (e.g., a vehicular collision or other incident resulting in injury and/or property damage) has occurred. In response to detecting an event and/or receiving input from the user 114 (e.g., as a voice command) that an event has occurred, instructional computing system 110 may prompt the user 114 to interact with a live instructor 118 and/or replicant persona in VR instructional environment 112 as described above.

Instructional computing system 110 may provide guidance and/or instructions to the user 114 via the user computing device 130, for example, as prompts displayed within VR instructional environment 112 and/or instructions provided by an instructor avatar. These prompts may include text or speech (e.g., speech associated with the virtual avatars 148 described above). The prompts may include questions verifying that the user 114 is not injured or to provide information about what has occurred. For example, the prompts may instruct the user 114 to take pictures and/or ask questions to others present at the scene of the event.

The user computing device 130 may also passively collect data, such as image and/or audio data, in response to the event being detected. This collected information may be used to determine if additional resources, such as emergency personnel or insurance personnel, need to be contacted, and automatically initiate such contact (e.g., by initiating an emergency “9-1-1” call and/or presenting an instructor avatar 148 within VR instructional environment 112 as described above). The collected information may further be used to generate digital twins, simulations, and/or visual reconstructions of the event, which may be used to determine an extent of damage or injury that has occurred and the cause of the event, such as which vehicle or vehicle system was at fault for the event. In some embodiments, these reconstructions may be viewed within VR instructional environment 112.

In the exemplary embodiment, instructional computing system 110 may be configured to receive sensor data from the user computing devices 130. For example, at least some of the user computing device 130 may include cameras, microphones, motion sensors (e.g., accelerometers and/or gyroscopes), location sensors (e.g., GPS), radar, lidar, and/or any other types of sensors. This data may be received (e.g., continuously, or periodically) prior to, during, and following an event. As described in further detail below, this senor data may be used by instructional computing system 110 to determine when an event has occurred and to gather information about the nature, scene, context, and results of the event.

In the exemplary embodiment, instructional computing system 110 may be further configured to determine, based upon the received sensor data, that an event has occurred. In some embodiments, this determination may be made by analyzing audio, video, and/or motion data, for example, using AI and/or machine learning techniques and/or by comparing such data to one or more predefined thresholds indicative that an event has occurred (e.g., a vehicle decelerating more quickly that would be possible using the brakes).

In some embodiments, the determination may be made based upon detected voice, speech, facial expressions, and/or gestures made by the user 114 or other individuals in the area. For example, in some embodiments, instructional computing system 110 may utilize specific voice commands or phrases made by the user 114 (e.g., saying “in an event”) to determine an event has occurred and initiate an appropriate response. Additionally, or alternatively, instructional computing system 110 may analyze non-structured speech or voice (e.g., using AI and/or chatbots) to determine that the non-structured speech or voice indicates an event has occurred. When it is determined an event has occurred, the user 114 may be alerted to launch or access VR instructional environment 112 via the user 114 computing device using voice commands.

In some embodiments, instructional computing system 110 may be configured to detect one or more voice commands input by the first user 114 to the first user computing device 130. As described above, some of these voice commands may relate to an indication that an event has occurred. Additionally, the voice commands may request specific actions, such as contacting an instructor 118 (e.g., by saying “contact my instructor”) or calling emergency services (e.g., by saying “call 9-1-1”).

Instructional computing system 110 may analyze these voice commands (e.g., using AI and/or chatbots and/or by performing a lookup based upon the received speech) to determine an appropriate response. For example, saying “contact my instructor” may bring the instructor 118, instructor's staff, instructor machine learning bot/avatar 148 or replicant persona, or claim representative into the metaverse channel for discussion or other interaction with the user 114. For example, instructional computing system 110 may present within the virtual instructional environment 112 to an instructor 118 using an instructor device of the user computing devices 130, a prompt to communicate with the user 114 within the virtual instructional environment 112.

As described above, instructional computing system 110 may generate responses to be performed by avatars 148 and/or recommended to live instructors 118 and/or other instructor personnel and may retrieve relevant policy documents for review by the instructor. In some embodiments, instructional computing system 110 may determine to perform these actions (e.g., contacting emergency personnel) even without a specific voice command. For example, if instructional computing system 110 determines a sufficiently severe event has occurred, instructional computing system 110 may automatically contact emergency personnel through an appropriate channel to request assistance and/or provide relevant information (e.g., a location of the event and/or identities of persons involved).

In the exemplary embodiment, in response to determining the event has occurred, instructional computing system 110 may be configured to present within VR instructional environment 112 one or more prompts for collecting information relating to the event using the user computing device 130. The prompts may be presented as text, audible commands, and/or statements made by avatars 148 within VR instructional environment 112. Examples of such prompts may include instructions to take pictures of the event scene and where and/or questions to ask others at the scene of the event. In some embodiments, these prompts may be generated using AI and/or chatbot technology, for example, to gather as much information as possible relevant to completing an insurance claim. Instructional computing system 110 may record interactions or other information resulting from the user 114 following these instructions. This information, such as the captured pictures and/or statements made by others at the scene of the event (e.g., witness accounts of what happened, statements indicating what happened or indications innocence, contact information, etc.), may be transmitted by the user computing device 130 back to instructional computing system 110 to be recorded and/or analyzed further.

In some embodiments, instructional computing system 110 may automatically identify other individuals at the scene of the event. For example, instructional computing system 110 may detect one or devices proximate to the user computing device 130 (e.g., using Bluetooth device identification and/or another appropriate form of wireless communication), and may perform a lookup to identify individuals present at a scene of the event based upon the detected one or more devices. In some embodiments, instructional computing system 110 may identify individuals based upon detecting and analyzing voices of or statements made by the individuals detected by the user computing device 130.

In the exemplary embodiment, instructional computing system 110 may be further configured to generate an event profile including the information collected by the user 114 using the first user computing device 130 in response to the one or more prompts. The event profile may be a database, database component, and/or data structure (e.g., stored in database 140) that stores various types of information associated with the event. In addition to the sensor data and information gathered by the user 114 associated with the event, other relevant data may be recorded in association with the event profile, such as a date, time, location, weather, traffic, maps, geographic models, or vehicle models, and/or other data associated with or providing context to the event. In some embodiments, instructional computing system 110 may retrieve additional documents, such as a police report, insurance policy documents, insurance claim documents, and/or estimates or receipts from mechanics associated with the event and store these documents in association with the event profile.

In some embodiments, instructional computing system 110 may generate one or more digital twins representing people, vehicles, or other objects involved in the event and/or a visual representation and/or reconstruction of the event based upon information included in the event profile. For example, instructional computing system 110 may parse the event profile for sensor data, speech data, and/or documents relating to the event to identify positions and orientations of relevant people and objects during the course of the event. In some embodiments, AI and/or machine learning techniques may be utilized for such parsing. In various embodiments, instructional computing system 110 the visual representation may be presented within VR instructional environment 112, so that instructors 118, trainees 116, and/or others reviewing the event may do so in a three-dimensional environment.

### Exemplary Instruction Exercise

FIG. 3 depicts an exemplary instruction exercise 122 for use with the instructional system 100 shown in FIG. 1. The instruction exercise 122 includes the virtual instructional environment 112 that may be displayed on the user computing device 130 (e.g., the instructor computing device 136, the trainee computing device 132, and/or the client computing device 138) and one or more avatars 148 representing one or more users 114 (e.g., the instructor 118, the trainee 116, and/or the client 120). In the exemplary embodiment, the instruction exercise 122 includes the instruction recommendation message 150, presented to the trainee computing device 132 and/or the instructor computing device 136, within the virtual instructional environment 112. In some alternative embodiments, the instruction recommendation message 150 may be presented outside of the virtual instructional environment 112. The instruction recommendation message 150 may include feedback, e.g., regarding the trainee's 116 performance during the instruction exercise, warnings, a script for the trainee 116 to communicate to the client 120 during a current interaction, phrases, or words to avoid using, policy data relevant to the current interaction. The instruction recommendation 150 may include any suitable teaching or instruction data, e.g., that the instructor 118 wishes to communicate to the trainee 116, e.g., without the knowledge of the client 120.

In some embodiments, current interactions, e.g., between the trainee 116 and the client 120 and/or the instructor 118 may be continuously or semi continuously applied to a trained instructional recommendation model to generate one or more model outputs including one or more instruction recommendation messages including feedback, warning, emotional state of client, scripted text, phrases, or words to avoid, and/or the policy data. The current interaction may be applied to the instruction recommendation model in real-time such that model outputs may be transmitted to the trainee computing device 132 such that the trainee 116 may utilize the instruction recommendation message 150 in real time during the current interaction. For example, responses, statements, body language, facial expressions, biometric parameters of the client 120, as sensed by sensors 154, during a current interaction of the instruction exercise 122, may be applied to the instruction recommendation model 152 to determine model outputs including feedback that indicates to the trainee 116 the emotional state of the client, a script that the trainee 116 may communicate to the client 120. The script may be a phrase or in sentence form, such that the trainee 116 may merely repeat or say the script verbatim to the client 120. The script or teleprompt is also associated with the determined emotional state of the client, and as such, the script may include language that addresses the emotional state, e.g., word or phrase of sympathy.

The virtual instructional environment 112 may be generated and provided via one or more computing devices 130 and/or the instructional computing system 110 of the instructional system 100 depicted in FIG. 1, and/or via other suitable computing devices. The virtual instructional environment 112 may include additional, fewer, or alternate elements to those depicted in FIG. 3, including any components of a virtual environment described in this detailed description.

The perspective of the virtual instructional environment 112 shown in FIG. 3 corresponds to one possible view of a three-dimensional virtual space represented by the virtual instructional environment 112. FIG. 3 shows an “ground view” or “eye level” perspective view, however additional or alternative views may be displayed to a user 114. Alternative views may include, for example and without limitation, a typical view for a user 114 in the VR instructional environment 112 may correspond to a viewing perspective (e.g., position and viewing angle) of a user 114, while the user is in a standing or seated position. The viewing perspective of the user 114 may vary in accordance with the user's navigation about the virtual instructional environment 112. In some embodiments, a view from the perspective of the user 114 may be considered an “overhead” view, the user 114 may, in some embodiments, move vertically about the virtual instructional environment 112 to access an overhead view of the virtual instructional environment 112. Accordingly, numerous views of the virtual instructional environment 112 are possible and available for access to the user.

In embodiments described herein the virtual instructional environment 112 may represent any suitable environment, for example and without limitation, an interior of an office space enabling virtual collaboration, e.g., between instructors 118 and trainees 116, a street view of homes or buildings enabling virtual inspection of damage (e.g., hail or wind) to the exterior of the home or buildings, and/or an interior of home or building enabling inspection of damage (e.g., flood or fire) to the interior of the home and/or objects within the home. In some embodiments, the instruction module 144 may generate one or more virtual environments within a single instruction exercise, and alternative between causing the user computing device 130 to display the different virtual environments. For example, a single instruction exercise may include a first virtual environment displaying a residential location and second virtual environment displaying the same residential location after an incident has occurred, e.g., after a flood, hail, fire, etc.

In some alternative embodiments, the virtual instructional environment 112 may include terrain, roads, intersection, bridges, overpasses, rivers, foliage, lakes, and/or rivers etc. The virtual instructional environment 112 may include additional or alternative components, including but not limited to signs, traffic lights, vehicles, and/or utility components (e.g., power lines) providing electricity to and/or other components of the virtual instructional environment 112.

The virtual instructional environment 112 may include a plurality of virtual properties, which may include various commercial properties, residential properties, and/or other properties described herein, including combinations thereof. Any virtual property may be associated with one or more entities (e.g., property owners, renters, lessors, etc.). In some embodiments, the virtual instructional environment 112 may additionally or alternatively include an “undeveloped” property, i.e., a property upon which a structure is not yet present or fully constructed, but which may still be considered for insurability based upon one or more aspects of the virtual instructional environment 112.

Various characteristics of the virtual instructional environment 112 may be randomly generated according to the techniques described herein. For example, procedural generation techniques may be applied to determine (1) material composition of structures upon the virtual properties, (2) varying elevation of the terrain of the virtual instructional environment 112, (3) rotation, size, and/or placement of various components of the virtual instructional environment 112, and/or (4) meteorological elements (e.g., clouds, rain, etc.) of the virtual instructional environment 112.

As described herein, the instructional system 100 may generate personalized virtual content for an instruction exercise. In some embodiments, the instruction module 144 stores a plurality of instruction exercises 122 each associated with a virtual instructional environment 112. The user may provide the instructional system 100 with a criterion of a desired instruction exercise, and the instruction module 144 and/or the instructional system 100 may generated personalized content based upon the received criterion. The instructional system 100 may generate a new virtual instructional environment 112 based upon the criterion, and/or historical interactions, by applying the criterion to a trained instruction exercise model. In some alternative embodiments, the instruction module 144 may select a pre-existing instruction exercise, e.g., stored within the instruction module 144, based upon the received criterion.

Additionally, the instructional system 100 may determine personalized virtual content in the form of virtual objects such as buildings, cars, rooms, landmarks, geological features, etc. based upon received data collected by user computing devices 130. The instructional system 100 may then generate one or more of the determined virtual objects based upon the virtual instructional environment 112, the personal data, and the determined training content. The instructional system 100 then provides, via the user computing device 130, such as a virtual headset, the virtual instructional environment 112, one or more virtual objects, avatars 148, and/or the instruction recommendation message 150 to the user 114 of the user computing device 130. The user 114 may interact in the virtual instructional environment 112 via interface hardware such as a keyboard, joystick, or other physical controller, or the user may provide inputs via a virtual user interface, motion tracking, and/or hand and gesture identification/tracking.

In some embodiments, a view of the user 114 in the virtual instructional environment 112 may comprise only a portion of the above-described components of the virtual instructional environment 112. In particular, due to computing limitations such as limited RAM, a view of the user 114 may be adjusted based upon computing capabilities of the device at which the virtual instructional environment 112 is provided. For example, when certain components of the virtual instructional environment 112 are outside of a limited “draw distance” of the user 114, are only in the periphery of the viewing angle of the user 114, or are obstructed by other components of the virtual instructional environment 112, the view of the virtual instructional environment 112 (1) limit graphical resolution of those certain components, (2) limit the visual detail of those certain components (e.g., by not including smaller “sub-components”), and/or (3) may omit those certain components entirely.

### Exemplary Client Device

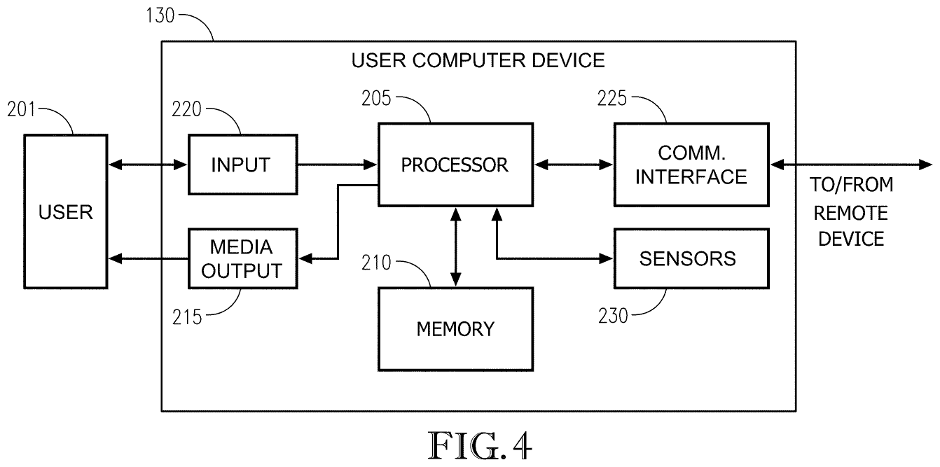

FIG. 4 depicts an exemplary configuration of a user computing device 130 shown in FIG. 1, in accordance with one embodiment of the present disclosure. User computing device 130 may be operated by a user 201. User computing device 130 may include a processor 205 for executing instructions. In some embodiments, executable instructions are stored in a memory area 210. Processor 205 may include one or more processing units (e.g., in a multi-core configuration). Memory area 210 may be any device allowing information such as executable instructions and/or transaction data to be stored and retrieved. Memory area 210 may include one or more computing readable media.

User computing device 130 may also include at least one media output component 215 for presenting information to user 201. Media output component 215 may be any component capable of conveying information to user 201. In some embodiments, media output component 215 may include an output adapter (not shown) such as a video adapter and/or an audio adapter. An output adapter may be operatively coupled to processor 205 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 215 may be configured to present a graphical user interface (e.g., a web browser and/or a client application) to user 201. A graphical user interface may include, for example, an online store interface for viewing and/or purchasing items, and/or a wallet application for managing payment information and/or any other interface that may be required within a virtual instructional environment. In some embodiments, user computing device 130 may include an input device 220 for receiving input from user 201. User 201 may use input device 220 to, without limitation, select and/or enter one or more items to purchase and/or a purchase request, or to access credential information, and/or payment information.

Input device 220 may include, for example, a keyboard, a pointing device, a mouse, a stylus, a touch sensitive panel (e.g., a touch pad or a touch screen), and other input mechanisms. Sensors 230 may include a gyroscope, an accelerometer, a position detector, a biometric input device, an audio input device (e.g., a microphone), and/or a video input device (e.g., a camera) and/or other sensors discussed herein. A single component such as a touch screen may function as both an output device of media output component 215 and input device 220.

User computing device 130 may also include a communication interface 225, communicatively coupled to a remote device such as instructional computing system 110 (shown in FIG. 1). Communication interface 225 may include, for example, a wired or wireless network adapter and/or a wireless data transceiver for use with a mobile telecommunications network.

Stored in memory area 210 are, for example, computing readable instructions for providing a user interface to user 201 via media output component 215 and, optionally, receiving and processing input from input device 220. A user interface may include, among other possibilities, a web browser and/or a client application. Web browsers enable users, such as user 114, to display and interact with media and other information typically embedded on a web page or a website from the instructional computing system 110 and/or the instruction module 144. A client application allows user 201 to interact with, for example, the instructional computing system 110 and/or the instruction module 144. For example, instructions may be stored by a cloud service, and the output of the execution of the instructions sent to the media output component 215.

Processor 205 executes computing-executable instructions for implementing aspects of the disclosure. In some embodiments, the processor 205 is transformed into a special purpose microprocessor by executing computing-executable instructions or by otherwise being programmed.

### Exemplary Server Device

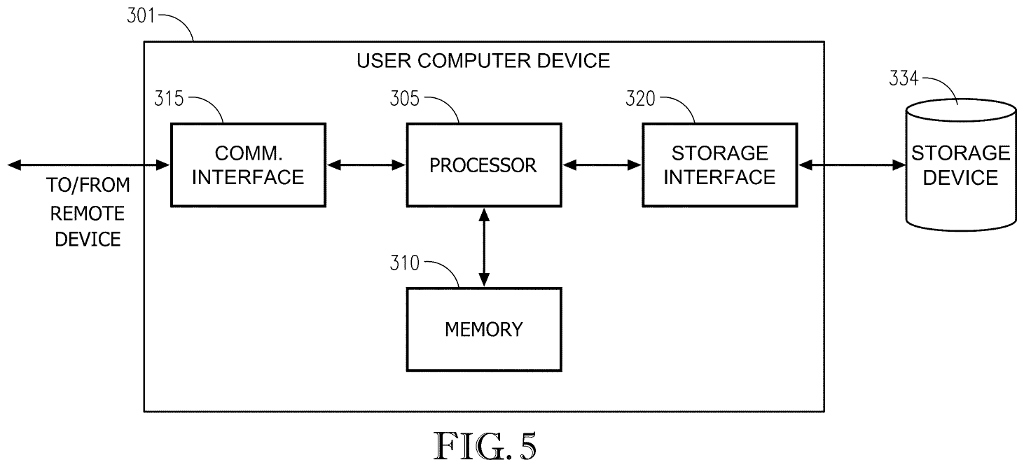

FIG. 5 depicts an exemplary configuration of a server computing device 301, in accordance with one embodiment of the present disclosure. Server computing device 301 may include, but is not limited to, instructional computing system 110 and/or instruction module 144 (all shown in FIG. 1). Server computing device 301 may also include a processor 305 for executing instructions. Instructions may be stored in a memory area 310. Processor 305 may include one or more processing units (e.g., in a multi-core configuration).

Processor 305 may be operatively coupled to a communication interface 315 such that server computing device 301 is capable of communicating with a remote device such as another server computing device 301, instruction module 144, or user computing devices 130 (shown in FIGS. 1 and 2). For example, communication interface 315 may receive requests from user computing devices 130 via the Internet.

Processor 305 may also be operatively coupled to a storage device 334. Storage device 334 may be any computing-operated hardware suitable for storing and/or retrieving data, such as, but not limited to, data associated with database 140 (shown in FIG. 1). In some embodiments, storage device 334 may be integrated in server computing device 301. For example, server computing device 301 may include one or more hard disk drives as storage device 334.

In other embodiments, storage device 334 may be external to server computing device 301 and may be accessed by a plurality of server computing devices 301. For example, storage device 334 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 334 via a storage interface 320. Storage interface 320 may be any component capable of providing processor 305 with access to storage device 334. Storage interface 320 may include, for example, an Advanced Technology Attachment (ATA) adapter, a Serial ATA (SATA) adapter, a Small Computing System Interface (SCSI) adapter, a RAID controller, a SAN adapter, a network adapter, and/or any component providing processor 305 with access to storage device 334.

Processor 305 may execute computing-executable instructions for implementing aspects of the disclosure. In some embodiments, the processor 305 may be transformed into a special purpose microprocessor by executing computing-executable instructions or by otherwise being programmed.

### Exemplary Computer-Implemented Method for Interactions in a Virtual Instructional Environment

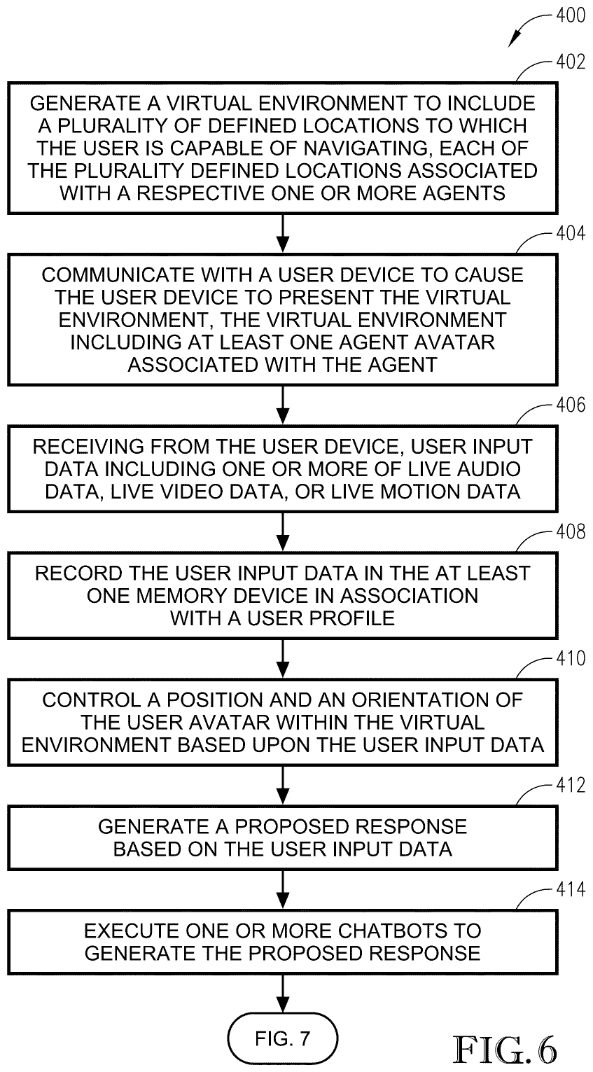

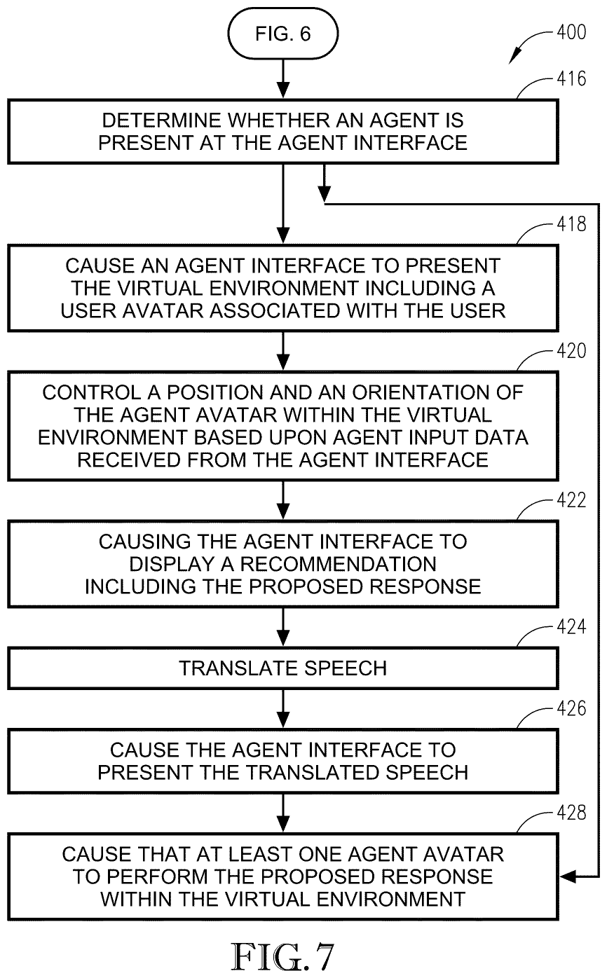

FIGS. 6 and 7 depict a flow chart of an exemplary computer-implemented process 400 for interaction with at least one user in a virtual instructional environment 112 using the instructional system 100 shown in FIG. 1. Process 400 may be implemented by a computing device, for example instructional computing system 110 and/or instruction module 144 (shown in FIG. 1). In the exemplary embodiment, instructional computing system 110 may be in communication with one or more instruction modules 144 and one or more user computing devices 130 (both shown in FIG. 1).

In some embodiments, process 400 may include generating 402 the virtual instructional environment 112 to include a plurality of defined locations to which the user is capable of navigating, each of the plurality of defined locations associated with a respective one or more instructors 118. In some embodiments, this action or operation may be performed by instructional computing system 110 and/or instruction module 144 (shown in FIG. 1).

In the exemplary embodiment, process 400 may include communicating 404 with the user computing device to cause the user computing device to present the virtual instructional environment 112, the virtual instructional environment 112 including at least one instructor avatar 148 associated with the instructor 118. In some embodiments, this action or operation may be performed by instructional computing system 110 and/or instruction module 144 (shown in FIG. 1).

In the exemplary embodiment, process 400 may further include receiving 406, from the user computing device, user input data including one or more of live audio data, live video data, or live motion data. In some embodiments, this action or operation may be performed by instructional computing system 110 and/or instruction module 144 (shown in FIG. 1).

In some embodiments, process 400 may further include recording 408 the user input data in the at least one memory device in association with a user profile. In some embodiments, this action or operation may be performed by instructional computing system 110 and/or instruction module 144 (shown in FIG. 1).

In some embodiments, process 400 may further include controlling 410 a position and an orientation of the user avatar 148 within the virtual instructional environment 112 based upon the user input data. In some embodiments, this action or operation may be performed by instructional computing system 110 and/or instruction module 144 (shown in FIG. 1).

In the exemplary embodiment, process 400 may further include generating 412 a proposed response based upon the user input data. In some embodiments, this action or operation may be performed by instructional computing system 110 and/or instruction module 144 (shown in FIG. 1).

In some embodiments, process 400 may further include executing 414 one or more chatbots to generate the proposed response. In some embodiments, this action or operation may be performed by instructional computing system 110 and/or instruction module 144 (shown in FIG. 1).

In the exemplary embodiment, process 400 may further include determining 416 whether an instructor 118 is present at the interface of user computing device. In some embodiments, this action or operation may be performed by instructional computing system 110 and/or instruction module 144 (shown in FIG. 1).

In some embodiments, process 400 may further include causing 418 the interface of user computing device to present the virtual instructional environment 112 including a user avatar 148 associated with the user. In certain embodiments, this action or operation may be performed by instructional computing system 110 and/or instruction module 144 (shown in FIG. 1).

In various embodiments, process 400 may further include controlling 420 a position and an orientation of the instructor avatar 148 within the virtual instructional environment 112 based upon instructor input data received from the interface of user computing device. In some embodiments, this action or operation may be performed by instructional computing system 110 and/or instruction module 144 (shown in FIG. 1).

In the exemplary embodiment, process 400 may further include, when the instructor 118 is present at the interface of user computing device, causing 422 the interface of user computing device to display an instruction recommendation including the proposed response. In some embodiments, this action or operation may be performed by instructional computing system 110 and/or instruction module 144 (shown in FIG. 1).

In some embodiments, the user input data includes speech, and process 400 further includes, when the instructor 118 is present at the interface of user computing device, translating 424 the speech. In such embodiments, process 400 may further include causing 426 the interface of user computing device to present the translated speech. In some embodiments, this action or operation may be performed by instructional computing system 110 and/or instruction module 144 (shown in FIG. 1).

In the exemplary embodiment, process 400 further includes, when the instructor 118 is not present at the interface of user computing device, causing 428 that at least one instructor avatar 148 to perform the proposed response within the virtual instructional environment 112. In some embodiments, this action or operation may be performed by instructional computing system 110 and/or instruction module 144 (shown in FIG. 1).

### Exemplary Computer-Implemented Method for Generating an Avatar

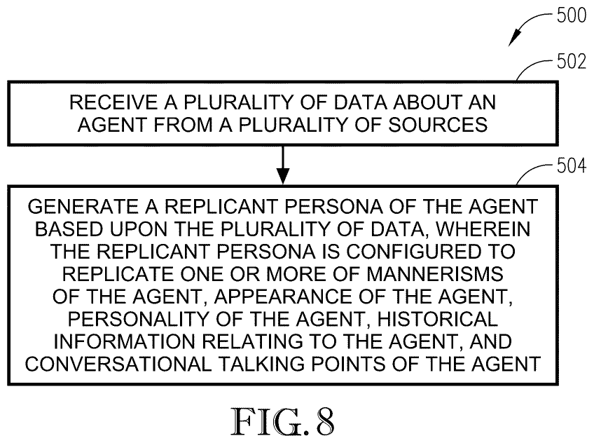

FIG. 8 depicts a flow chart of an exemplary computer-implemented process 500 for generating an avatar 148 for an instructor 118 or other individual using instructional system 100 shown in FIG. 1. Process 500 may be implemented by a computing device, for example instructional computing system 110 and/or instruction module 144 (shown in FIG. 1). In the exemplary embodiment, instructional computing system 110 may be in communication with one or more instruction modules 144 and one or more user computing devices 130 (both shown in FIG. 1).

In the exemplary embodiment, process 500 may include receiving 502 a plurality of data about the instructor 118 from a plurality of sources. In some embodiments, this action or operation may be performed by instructional computing system 110 and/or instruction module 144 (shown in FIG. 1).

In the exemplary embodiment, process 500 may include generating 504 a replicant persona of the instructor 118 based upon the plurality of data, wherein the replicant persona is configured to replicate one or more of mannerisms of the instructor 118, appearance of the instructor 118, personality of the instructor 118, historical information relating to the instructor 118, and conversational talking points of the instructor 118. The proposed response referred to with respect to process 400 (shown in FIGS. 4A and 4B) may be generated based at least in part upon the replicant persona. In some embodiments, the mannerisms of the instructor 118 may include one or more of: hand gestures of the instructor 118, facial gestures of the instructor 118, body language of the instructor 118, a speaking accent of the instructor 118, a dialect of the instructor 118, a personality of the instructor 118, or emotions of the instructor 118. In some embodiments, the plurality of data includes social media, behavior data from interviews, recordings, images, and/or historical data about the instructor 118. In various embodiments, this action or operation may be performed by instructional computing system 110 and/or instruction module 144 (shown in FIG. 1).

In some embodiments, the avatar 148 is representative of an actual user 114 that is currently, in real-time, interacting with instructional system 100. For example, the avatar 148 is representative of the current and actual behavior of the actual user 114, using sensor data collected in real-time, e.g., by one or more devices in proximity to the user 114. In some other embodiments, the avatar 148 is representative an actual user 114 that is not currently interacting with instructional system 100, rather the avatar 148 may represent potential interactions of the actual user 114, e.g., phrases, mannerisms, previously answered questions, etc. For instance, the avatar 148 may be generated while the actual user 114 is off-line and not interacting with instructional system 100. In some embodiments, the avatar 148 may not represent an actual or individual user 114, rather, the avatar 148 may be generated based upon a plurality of actual users 114, training material or documents retrieved from the database 140 or additional or alternative sources.

### Exemplary Computer-Implemented Method for Providing Secure Data Exchange in Virtual Instructional Environment

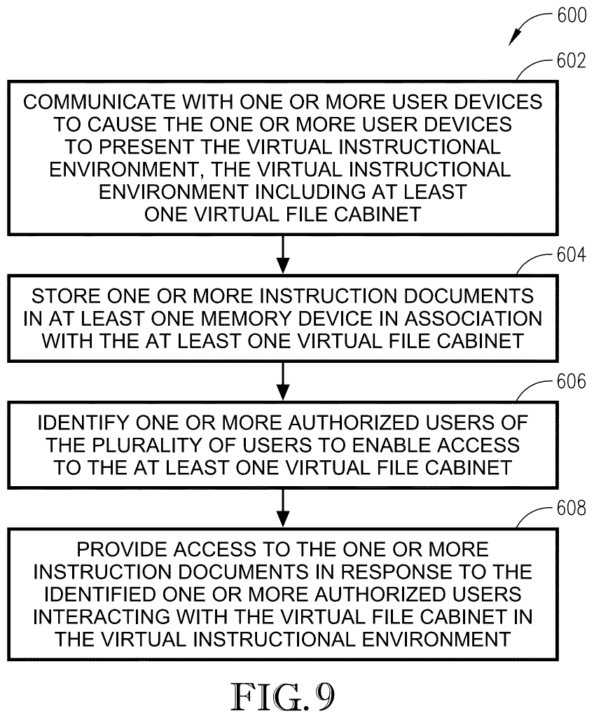

FIG. 9 depicts a flow chart of an exemplary computer-implemented process 600 for providing secure data exchange in a virtual environment such as VR instructional environment 112 using instructional system 100 shown in FIG. 1. Process 600 may be implemented by a computing device, for example instructional computing system 110 and/or instruction module 144 (shown in FIG. 1). In the exemplary embodiment, instructional computing system 110 may be in communication with one or more instruction modules 144 and one or more user computing devices 130 (both shown in FIG. 1).

In the exemplary embodiment, process 600 may include communicating 602 with the one or more user computing devices 130 to cause the one or more user computing devices 130 to present the virtual instructional environment 112, the virtual instructional environment 112 including at least one virtual file cabinet (e.g., associated with a first user 114 of the plurality of users 114). In some embodiments, this action or operation may be performed by instructional computing system 110 and/or instruction module 144 (shown in FIG. 1).

In the exemplary embodiment, process 600 may further include storing 604 one or more instruction documents (e.g., instruction recommendation messages 150 and/or policy information) in the at least one memory device in association with the at least one virtual file cabinet. In some embodiments, this action or operation may be performed by instructional computing system 110 and/or instruction module 144 (shown in FIG. 1).

In the exemplary embodiment, process 600 may further include identifying 606 one or more authorized users 114 of the plurality of users 114 to enable access to the at least one virtual file cabinet. In some embodiments, this action or operation may be performed by instructional computing system 110 and/or instruction module 144 (shown in FIG. 1).

In the exemplary embodiment, process 600 may further include providing access 608 to the one or more documents in response to the identified one or more authorized users 114 interacting with the virtual file cabinet in the virtual instructional environment 112. In some embodiments, this action or operation may be performed by instructional computing system 110 and/or instruction module 144 (shown in FIG. 1).

In some embodiments, process 600 may include exchanging data and/or one or more documents from within the virtual instructional environment 112 to an external environment. In some embodiments, data collected within the virtual environment may be securely, e.g., via encryption, transmitted outside of the virtual instructional environment 112, e.g., to the user computing devices 130. The instructional system 100 is enabled to provide interoperability between an external system and the virtual instructional environment 112, while safely and securely enabling data to be transferred. For example, a trainee's 116 performance during an instruction exercise may be transferred from within the virtual instructional environment 112 to the instructor computing device 136 outside of the virtual instructional environment 112, e.g., presenting the data using a program, a visual display, or a graphical user interface not associated with the virtual instructional environment 112.

### Exemplary Computer-Implemented Method for Providing Real Time Instructional Recommendations in a Virtual Instructional Environment

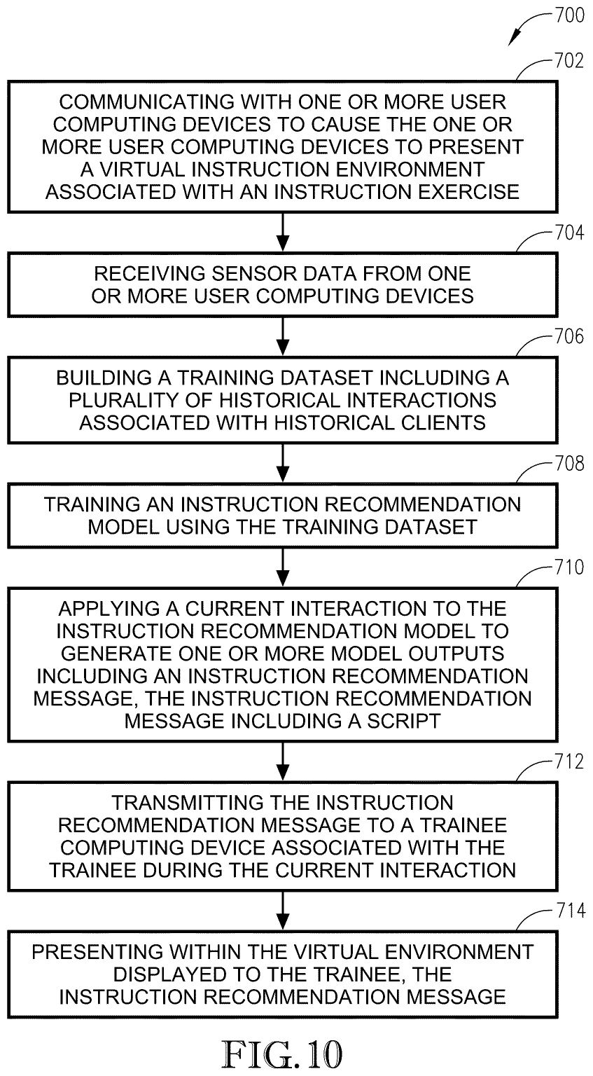

FIG. 10 depicts a flow chart of an exemplary computer-implemented process 700 for providing real time instruction recommendations in a virtual instructional environment 112 such as VR instructional environment 112 using instructional system 100 shown in FIG. 1. Process 700 may be implemented by a computing device, for example instructional computing system 110 and/or instruction module 144 (shown in FIG. 1). In the exemplary embodiment, instructional computing system 110 may be in communication with one or more instruction modules 144 and one or more user computing devices 130 (both shown in FIG. 1).

In the exemplary embodiment, process 700 may include communicating 702 with one or more user computing devices 130 to cause the one or more user computing devices 130, e.g., the trainee computing device 132, the instructor computing device 136, and/or the client computing device 138, to present a virtual instructional environment 112 associated with an instruction exercise. In some embodiments, this action or operation may be performed by instructional computing system 110 and/or instruction module 144 (shown in FIG. 1).

In the exemplary embodiment, process 700 may further include receiving 704 sensor data from one or more user computing devices 130, e.g., the trainee computing device 132, the instructor computing device 136, and/or the client computing device 138. In some embodiments, this action or operation may be performed by instructional computing system 110 and/or instruction module 144 (shown in FIG. 1). Sensor data may include audio, visual, video stream, or any suitable data to capture interactions between the users 114. In certain embodiments, sensor data may include biometric sensors data, e.g., heart rate, stress levels, sweat levels, etc.

In the exemplary embodiment, process 700 may further include, building 706 a training dataset including a plurality of historical client interaction records 142, e.g., historical instruction exercises 122, historical interactions between clients 120 and trained or seasoned employees, and/or any suitable historical interaction. The historical interaction records 142 included in the training dataset may include interactions that were positive, e.g., based upon client feedback or upon screening or review of the historical interaction. Similarly, historical interaction records 142 that were negative, e.g., based upon client feedback or based upon a review of the historical interaction, may be excluded from the training dataset.

In the exemplary embodiment, process 700 may further include training 708 an instruction recommendation model using the training dataset. Training 708 may include training, or re-training, using updated or new historical interactions or records 142, tuning, adjusting weighting factors, etc., in order to generate the instruction recommendation model. The instruction recommendation model is trained to generate one or more model outputs when one or more model inputs are applied to the instruction recommendation model. Model inputs may include a current interaction. For example, model inputs may include data collected during an interaction between the trainee 116 and the client 120, such as audio data of the client 120 or trainee 116 speaking or asking questions, visual feedback of the client's 120 and/or trainee's 116 expressions and/or body language, biometrics, etc.

Process 700 includes applying 710 model inputs to the instruction recommendation model. Model inputs may be applied to the instruction recommendation model in real-time, to generate one or more model outputs that may be transmitted to the trainee 116, such that the trainee 116 may use the model output during the interaction with the client 120. Model outputs may include an instruction recommendation message, such as a script to be communicated by the trainee 116, information (e.g., policy information), a warning, phrases or words to avoid, an emotional state of the client (e.g., frustrated, confused, saddened, or worried) and/or any additional or alternative feedback or recommendation that may assist the trainee 116 in their interaction with the client 120.

Applying model inputs to the model in real-time during a current interaction between the client 120 and the trainee 116, enables the system 100 and/or the instruction recommendation model to evaluate the interaction in real-time, e.g., evaluate the facial expressions, body language, etc., of the client 120 to determine an emotional state of the client, which is particularly valuable for the trainee 116 to understand and/or recognize during client interaction.

In the exemplary embodiment, process 700 may further include, transmitting 712 the instruction recommendation message to one or more user computing devices 130, e.g., trainee computing device 132 and/or the instructor computing device 136 during the current interaction, e.g., during a current instruction exercise.

In the exemplary embodiment, process 700 may further include, presenting 714, within the virtual instructional environment 112, e.g., to the trainee 116 or instructor 118, using the trainee computing device 132, the recommendation message. In some embodiments, this action or operation may be performed by instructional computing system 110 and/or instruction module 144 (shown in FIG. 1). In some alternative embodiments, the recommendation message, or portions of the recommendation message, may be presented outside of the virtual instructional environment 112. In various embodiments, the instructional system 100 may perform real-time translations, e.g., if the client's 120 language is different than a language of the trainee 116 and/or the instructor 118.

In some embodiments, the process may include first transmitting the recommendation message 150 to the instructor computing device 136 for review and approval or editing, before an approved recommendation message 150 is transmitted to the trainee computing device 132.

### Exemplary Computer-Implemented Method for Providing Custom Instructional Exercises for a Trainee

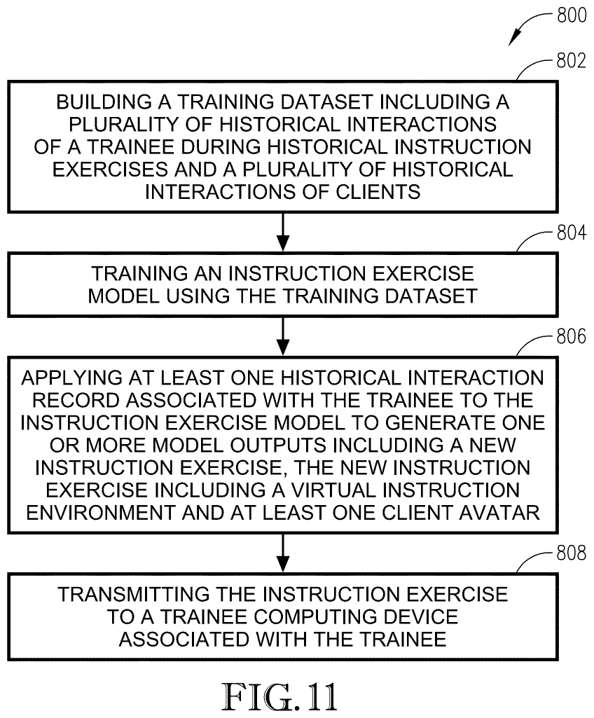

FIG. 11 depicts a flow chart of an exemplary computer-implemented process 800 for generating an instruction exercise for training or teaching purposes or to facilitate interactions between the trainee 116 and a client 120 or instructor 118. The instruction exercise 122 may include a virtual environment, such as VR instructional environment 112, using instructional system 100 and/or the instruction module 144 shown in FIG. 1. Process 800 may be implemented by a computing device, for example instructional computing system 110 and/or instruction module 144 (shown in FIG. 1). In the exemplary embodiment, instructional computing system 110 may be in communication with one or more instruction modules 144 and one or more user computing devices 130 (both shown in FIG. 1).

In the exemplary embodiment, process 800 may further include, building 802 a training dataset including a plurality of historical trainee interaction records 142, associated with a historical instruction exercises 122 of the trainee 116, and/or any suitable historical interactions between the trainee 116 and the client(s) 120 and/or the instructor 118. The historical trainee interaction record may include additional or alternative data, for example, the historical trainee interaction may be scored, ranked, and/or additional feedback data from the instructor 118 may be included data in the historical trainee interaction record.

In the exemplary embodiment, process 800 may including building the historical trainee interaction records 142 by receiving and/or saving sensor data from one or more user computing devices 130, e.g., the trainee computing device 132, the instructor computing device 136, and/or the client computing device 138, during the historical instruction exercise, to create a historical instruction record.

In some embodiments, building the training dataset or creating/updating historical trainee interaction records 142 may be performed by instructional computing system 110 and/or instruction module 144 (shown in FIG. 1).

In the exemplary embodiment, process 800 may further include training 804 an instruction exercise model using the training dataset. Training 804 may include training or re-training using updated or new historical interactions, tuning, adjusting weighting factors, etc., in order to generate the instruction exercise model. The instruction exercise model is trained to generate one or more model outputs when one or more model inputs are applied to the instruction recommendation model. Model inputs may include one or more historical trainee interaction records, e.g., a most recently completed instruction exercise completed by the trainee 116. For example, model inputs may include data collected during an interaction between the trainee 116 and the client 120, such as audio data of the client 120 or trainee 116 speaking or asking questions, visual feedback of the client's 120 and/or trainee's 116 expressions and/or body language, biometrics, etc., collected during the interaction.

Process 800 includes applying 806 model inputs to the instruction exercise model to generate one or more model outputs including a new or updated instruction exercise 122. The new or updated instruction exercise 122 may be a trainee 116 specific instruction exercise that is best suited and customized for a specific trainee 116 based upon the prior behavior or performance of the trainee 116 during historical interactions. The new instruction exercise 122 may include one or more virtual instructional environment 112 and one or more client avatars 148.

Applying 806 model inputs to the instruction exercise model may generate one or more additional or alternative model outputs. For example, model outputs may include a score that evaluates the performance of the trainee 116 and/or feedback describing the performance of the trainee 116. The model outputs including the score and feedback, may reduce the workload on the instructor 118. In another example, model outputs may include a recommendation and/or one or more criteria for subsequent instruction exercises 122 that should be conducted by the trainee 116. In some embodiments, recommendations may be used to select an instruction exercise 122 from a list of available pre-existing instruction exercises 122 or, the recommendation may be used to assignee the trainee 116 to an incoming event, e.g., an actual client 120.

In the exemplary embodiment, process 800 may further include, transmitting 808 the instruction exercise 122, and one or more other model outputs, to one or more user computing devices 130, e.g., trainee computing device 132 and/or the instructor computing device 136.

### Exemplary Embodiments & Functionality

In one aspect, a computing system for generating a virtual reality replicant user 114 for interaction with at least one user 114 may be provided. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, dermal patches, voice bots, chatbots, ChatGPT or ChatGPT-based bots, and/or other electronic or electrical components, which may be in wired or wireless communication with one another. For example, in one instance, the computing system may include at least one local or remote processor and/or associated transceiver in communication with at least one local or remote memory device and in communication with a user computing device 130 associated with a user 114 and with an interface of user computing device 130 associated with an instructor 118. The at least one processor may be programmed to: i) communicate with the one or more trainee computing devices each associated with a trainee to cause the one or more trainee computing devices to present the virtual instructional environment, wherein the virtual instructional environment is associated with an instructional exercise, the virtual instructional environment includes a client avatar, representing a client, for interactions with the trainee; ii) receive sensor data from at least one of the trainee computing device associated with the trainee and a client computing device associated with a client during a current interaction between the trainee and the client; iii) evaluate the current interaction between the trainee and the client by applying the received sensor data associated with the current interaction to a trained instructional recommendation model to generate one or more outputs including an instructional recommendation message including a script for the trainee to communicate during the current interaction; and/or iv) present, within the virtual instructional environment, to the trainee user computing device, the instruction message. The computing system may have additional, less, or alternate functionality, including that discussed elsewhere herein.

In another aspect, a computing-based or computer-implemented method for generating a virtual reality replicant persona for interaction with at least one user may be provided. The method may be implemented by a computing system including any of the electronic or electrical components discussed herein. For instance, the method may be implemented by at least one processor in communication with at least one memory device and in communication with a user computing device associated with a user and with an interface of user computing device associated with an instructor 118. The method may include: i) communicating with the one or more trainee computing devices each associated with a trainee to cause the one or more trainee computing devices to present the virtual instructional environment, wherein the virtual instructional environment is associated with an instructional exercise, the virtual instructional environment includes a client avatar, representing a client, for interactions with the trainee; ii) receiving sensor data from at least one of the trainee computing device associated with the trainee and a client computing device associated with a client during a current interaction between the trainee and the client; iii) evaluating the current interaction between the trainee and the client by applying the received sensor data associated with the current interaction to a trained instructional recommendation model to generate one or more outputs including an instructional recommendation message including a script for the trainee to communicate during the current interaction; and/or iv) presenting, within the virtual instructional environment, to the trainee user computing device, the instruction message. The method may include additional, less, or alternate actions, including those discussed elsewhere herein.

In yet another aspect, at least one non-transitory computing-readable media having computing-executable instructions embodied thereon is disclosed, the computing-executable instructions when executed by a computing system including at least one processor in communication with at least one memory device and in communication with a user computing device associated with a user and with an interface of user computing device associated with an instructor, the computing-executable instructions cause the at least one processor to: i) communicate with the one or more trainee computing devices each associated with a trainee to cause the one or more trainee computing devices to present the virtual instructional environment, wherein the virtual instructional environment is associated with an instructional exercise, the virtual instructional environment includes a client avatar, representing a client, for interactions with the trainee; ii) receive sensor data from at least one of the trainee computing device associated with the trainee and a client computing device associated with a client during a current interaction between the trainee and the client; iii) evaluate the current interaction between the trainee and the client by applying the received sensor data associated with the current interaction to a trained instructional recommendation model to generate one or more outputs including an instructional recommendation message including a script for the trainee to communicate during the current interaction; and/or iv) present, within the virtual instructional environment, to the trainee user computing device, the instruction message. The computing-executable instructions may direct additional, less, or alternate functionality, including that discussed elsewhere herein.

In another aspect, a virtual reality computing system for conducting instructional interactions between one or more user computing devices including a trainee computing device within a virtual environment is provided. The computing system includes at least one memory device and at least one processor in communication with the at least one memory device. The at least one processor is configured to: (i) communicate with the one or more user computing devices including the trainee computing device associated with a trainee to cause the one or more user computing devices to present the virtual environment, wherein the virtual environment includes a client avatar representing a client interacting with the trainee in an instructional exercise; (ii) receive sensor data from the trainee computing device associated with the trainee and a user computing device associated with the client during a current interaction between the trainee and the client within the virtual environment; (iii) evaluate the current interaction between the trainee and the client by inputting the received sensor data into a trained machine learning (ML) model to generate one or more outputs including an instructional message that includes scripted text for the trainee to communicate to the client during the current interaction within the virtual environment; and (iv) present on the trainee computing device the instructional message.

In another embodiment, the virtual reality computing system described herein may further include, in any combination, the at least one processor being configured to: (i) build a training dataset including a plurality of historical client interaction records including interaction data and sensor data associated with each of the interaction records; (ii) train the ML model using the training dataset; and (iii) input interaction data from one or more past interactions associated with the trainee into the trained ML model to generate a new instructional exercise for further training of the trainee within the virtual environment using the client avatar.

In another embodiment, the virtual reality computing system described herein may further include, in any combination, the instructional message includes one or more of the following: a warning to the trainee relating to the interacting with the client, policy data associated with the instructional exercise, and/or a measured emotional state of the client determined from the sensor data of the client.

In another embodiment, the virtual reality computing system described herein may further include, in any combination, the at least one processor being configured to: (i) build a training dataset including a plurality of historical client interaction records including audio and/or video interaction data between a client and a trained service provider, and sensor data associated with the corresponding client and service provider for each of the interaction records; and (ii) train the ML model using the training dataset to recommend a subsequent suggested interaction between a client and a service provider.

In another embodiment, the virtual reality computing system described herein may further include, in any combination, the virtual environment including an instructor avatar representing an instructor, the client avatar representing the client, and a trainee avatar representing the trainee, wherein interactions occur between the instructor, the client and the trainee within the virtual environment.

In another embodiment, the virtual reality computing system described herein may further include, in any combination, the at least one memory device storing a plurality of virtual instructional exercises, each including a virtual instructional environment for training the trainee, wherein the at least one processor is further configured to: (i) receive, from the trainee computing device and an instructor computing device associated with an instructor, criteria associated with an instructional exercise; based upon the criteria, determine a selected instructional exercise and an associated virtual instructional environment satisfying the criteria; and (ii) transmit the selected instructional exercise to one or more trainee computing devices each associated with a trainee to cause the one or more trainee computing devices to present the virtual environment associated with the selected instructional exercise.

In another embodiment, the virtual reality computing system described herein may further include, in any combination, the trainee computing device including one or more sensors for collecting the sensor data, wherein the sensors include at least one of a camera, a video, a microphone, a biometric sensor, radar, lidar, pressure sensor, temperature sensor, flow parameter sensor, and weather data.

In another embodiment, the virtual reality computing system described herein may further include, in any combination, the at least one processor being configured to: (i) further train the ML model using historical client interaction records between one or more trained service providers and clients; and (ii) generate, using the ML model, the client avatar representing the client and control the client avatar interactions with the trainee within the virtual environment.

In another embodiment, the virtual reality computing system described herein may further include, in any combination, the memory storing a plurality of virtual instruction exercises, each including a virtual instructional environment, for training a trainee, wherein the at least one processor is configured to select an instruction exercise from the plurality of instruction exercises for instructing the trainee, based, at least in part, one or more historical trainee interactions.

In another embodiment, the virtual reality computing system described herein may further include, in any combination, the at least one processor being configured to: transmit a message to a user computing device, the message including data associated with an interaction that occurred within the virtual instructional environment, causing the user computing device to present the data outside of the virtual instructional environment.

In another embodiment, the virtual reality computing system described herein may further include, in any combination, the at least one memory storing a plurality of instructional exercises, each of the plurality of instructional exercises includes a score associated with a complexity of the instructional exercise, and wherein the processor is further configured to: (i) select one of the plurality of instructional exercises based on the complexity score; (ii) cause the selected instructional exercise to be presented within the virtual environment; and (iii) prompt the trainee to interact with the client within the virtual environment as part of the selected instructional exercise.

In another embodiment, the virtual reality computing system described herein may further include, in any combination, the at least one processor being configured to: (i) compare the sensor data to one or more trigger criterion to determine if a criterion is satisfied, and (ii) if the sensor data satisfies the criterion, input the sensor data into the ML model to output the instruction message to the trainee for interacting with the client and control how the client avatar reacts to the interacting with the trainee.

In another aspect, a computer-implemented method for conducting interactions between a plurality of user computing devices including a trainee computing device within a virtual environment is provided. The computer-implemented method is performed by a computing device including at least one memory device and at least one processor in communication with the at least one memory device and one or more user computing devices. The computer-implemented method includes: (i) communicating with the one or more user computing devices including the trainee computing device associated with a trainee to cause the one or more user computing devices to present the virtual environment, wherein the virtual environment includes a client avatar representing a client interacting with the trainee in an instructional exercise; (ii) receiving sensor data from the trainee computing device associated with the trainee and a user computing device associated with the client during a current interaction between the trainee and the client within the virtual environment; (iii) evaluating the current interaction between the trainee and the client by inputting the received sensor data into a trained machine learning (ML) model to generate one or more outputs including an instructional message that includes a scripted text for the trainee to communicate to the client during the current interaction within the virtual environment; and (iv) presenting on the trainee computing device the instructional message.

In another embodiment, the computer-implemented method described herein may further include, in any combination, the steps of: (i) building a training dataset including a plurality of historical client interaction records including interaction data and sensor data associated with each of the interaction records; (ii) training the ML model using the training dataset; and (iii) inputting interaction data from one or more past interactions associated with the trainee into the trained ML model to generate a new instructional exercise for further training the trainee within the virtual environment using the client avatar.

In another embodiment, the computer-implemented method described herein may further include, in any combination, the instructional message including one or more of the following: a warning to the trainee relating to the interacting with the client, policy data associated with the instructional exercise, and/or an emotional state of the client determine from the sensor data of the client.

In another embodiment, the computer-implemented method described herein may further include, in any combination, the steps of: (i) building a training dataset including a plurality of historical client interaction records including audio and/or video interaction data between a client and a trained service provider, and sensor data associated with the corresponding client and service provider for each of the interaction records; and (ii) training the ML model using the training dataset to recommend a subsequent suggested interaction between a client and a service provider.

In another embodiment, the computer-implemented method described herein may further include, in any combination, the virtual environment including an instructor avatar representing an instructor, the client avatar representing the client, and a trainee avatar representing the trainee, wherein interactions occur between the instructor, the client and the trainee within the virtual environment.

In another embodiment, the computer-implemented method described herein may further include, in any combination, the at least one memory storing a plurality of virtual instructional exercises, each including a virtual instructional environment for training the trainee, wherein the method further comprises: (i) receiving, from the trainee computing device and an instructor computing device associated with an instructor, criteria associated with an instructional exercise; (ii) based upon the criteria, determining a selected instructional exercise and an associated virtual environment, satisfying the criteria; and (iii) transmitting the selected instructional exercise to one or more trainee computing devices each associated with a trainee to cause the one or more trainee computing devices to present the virtual environment associated with the selected instructional exercise.

In another embodiment, the computer-implemented method described herein may further include, in any combination, wherein the trainee computing device includes one or more sensors for collecting the sensor data, wherein the sensors include at least one of a camera, a video, a microphone, a biometric sensor, radar, lidar, pressure sensor, temperature sensor, flow parameter sensor, and weather data.

In another embodiment, the computer-implemented method described herein may further include, in any combination, the steps of: (i) training the ML model using historical client interaction records between one or more trained service providers and clients; and (ii) generate, using the ML model, the client avatar representing the client and controlling the client avatar interactions with the trainee within the virtual environment.

In another aspect, at least one non-transitory computer-readable storage media having computing-executable instructions embodied thereon for conducting instructional interactions between one or more user computing devices including a trainee computing device within a virtual environment is provided. When executed by a computing system including at least one memory device and at least one processor in communication with the at least one memory device and one or more user computing devices, the computer-executable instructions cause the at least one processor to: (i) communicate with the one or more user computing devices including the trainee computing device associated with a trainee to cause the one or more user computing devices to present the virtual environment, wherein the virtual environment includes a client avatar representing a client interacting with the trainee in an instructional exercise; (ii) receive sensor data from the trainee computing device associated with the trainee and a user computing device associated with the client during a current interaction between the trainee and the client within the virtual environment; (iii) evaluate the current interaction between the trainee and the client by inputting the received sensor data into a trained machine learning (ML) model to generate one or more outputs including an instructional message that includes scripted text for the trainee to communicate to the client during the current interaction within the virtual environment; and (iv) present on the trainee computing device the instructional message.

In another embodiment, the computer-executable instructions described herein may further perform the following, in any combination, when executed by the at least one processor: (i) build a training dataset including a plurality of historical client interaction records including interaction data and sensor data associated with each of the interaction records; (ii) train the ML model using the training dataset; and (iii) input interaction data from one or more past interactions associated with the trainee into the trained ML model to generate a new instructional exercise for further training of the trainee within the virtual environment using the client avatar.

In another embodiment, the computer-executable instructions described herein may further include, in any combination, the instructional message including one or more of the following: a warning to the trainee relating to the interacting with the client, policy data associated with the instructional exercise, and/or a measured emotional state of the client determined from the sensor data of the client.

In another embodiment, the computer-executable instructions described herein may further perform the following, in any combination, when executed by the at least one processor: (i) build a training dataset including a plurality of historical client interaction records including audio and/or video interaction data between a client and a trained service provider, and sensor data associated with the corresponding client and service provider for each of the interaction records; and (ii) train the ML model using the training dataset to recommend a subsequent suggested interaction between a client and a service provider.

In another embodiment, the computer-executable instructions described herein may further include the virtual environment including an instructor avatar representing an instructor, the client avatar representing the client, and a trainee avatar representing the trainee, wherein interactions occur between the instructor, the client and the trainee within the virtual environment.

In another embodiment, the computer-executable instructions described herein may further perform the following, in any combination, when executed by the at least one processor: (i) receive, from the trainee computing device and an instructor computing device associated with an instructor, criteria associated with an instructional exercise; based upon the criteria, determine a selected instructional exercise and an associated virtual instructional environment satisfying the criteria; and (ii) transmit the selected instructional exercise to one or more trainee computing devices each associated with a trainee to cause the one or more trainee computing devices to present the virtual environment associated with the selected instructional exercise.

In another embodiment, the computer-executable instructions described herein may further include, in any combination, the trainee computing device including one or more sensors for collecting the sensor data, wherein the sensors include at least one of a camera, a video, a microphone, a biometric sensor, radar, lidar, pressure sensor, temperature sensor, flow parameter sensor, and weather data.

In another embodiment, the computer-executable instructions described herein may further perform the following, in any combination, when executed by the at least one processor: (i) further train the ML model using historical client interaction records between one or more trained service providers and clients; and (ii) generate, using the ML model, the client avatar representing the client and control the client avatar interactions with the trainee within the virtual environment.

In another embodiment, the computer-executable instructions described herein may further include, in any combination, the memory storing a plurality of virtual instruction exercises, each including a virtual instructional environment for training a trainee, and wherein when executed by the at least one processor, the computer-executable instructions cause the at least one processor to: select an instruction exercise from the plurality of instruction exercises for instructing the trainee, based, at least in part, one or more historical trainee interactions.

In another embodiment, the computer-executable instructions described herein may further perform the following, in any combination, when executed by the at least one processor: transmit a message to a user computing device, the message including data associated with an interaction that occurred within the virtual instructional environment, causing the user computing device to present the data outside of the virtual instructional environment.

In another embodiment, the computer-executable instructions described herein may further includes, in any combination, the at least one memory storing a plurality of instructional exercises, each of the plurality of instructional exercises includes a score associated with a complexity of the instructional exercise, and wherein when executed by the at least one processor, the computer-executable instructions cause the at least one processor to: (i) select one of the plurality of instructional exercises based on the complexity score; (ii) cause the selected instructional exercise to be presented within the virtual environment; and (iii) prompt the trainee to interact with the client within the virtual environment as part of the selected instructional exercise.

In another embodiment, the computer-executable instructions described herein may further perform the following, in any combination, when executed by the at least one processor: (i) compare the sensor data to one or more trigger criterion to determine if a criterion is satisfied, and (ii) if the sensor data satisfies the criterion, input the sensor data into the ML model to output the instruction message to the trainee for interacting with the client and control how the client avatar reacts to the interacting with the trainee.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computing-executable instructions stored on non-transitory computing-readable media or medium.

Additionally, the computing systems discussed herein may include additional, less, or alternate functionality, including that discussed elsewhere herein. The computing systems discussed herein may include or be implemented via computing-executable instructions stored on non-transitory computing-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant data for users from mobile device sensors, vehicle-mounted sensors, home-mounted sensors, drone mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing sensor data, vehicle or home telematics data, image data, mobile device data, and/or other data. For example, the processing element may learn, with the user's permission or affirmative consent, to identify the type and number of goods within a home or other location, and/or purchasing patterns of the user, such as by analysis of virtual receipts, client virtual accounts with online or physical retailers, mobile device data, interconnected or smart home data, interconnected or smart vehicle data, etc. For the goods identified, a virtual inventory of personal items or personal articles may be maintained current and up to date. As a result, at the time of an event or simulated event damages the user's home or goods, providing prompt and accurate service to the user may be provided—such as accurate insurance claim handling, and prompt repair or replacement of damaged items for the user.

In some embodiments, voice bots or chatbots, such as those discussed herein, may be configured to utilize AI (artificial intelligence) and/or ML (machine learning) techniques. For instance, the chatbot may be a large language model such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### Additional Considerations

As will be appreciated based upon the foregoing specification, the above-described embodiments of the disclosure may be implemented using computing programming or engineering techniques including computing software, firmware, hardware or any combination or subset thereof. Any such resulting program, having computing-readable code means, may be embodied, or provided within one or more computing-readable media, thereby making a computing program product, i.e., an article of manufacture, according to the discussed embodiments of the disclosure. The computing-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computing code may be made and/or used by executing the code directly from one medium, by copying the code from one medium to another medium, or by transmitting the code over a network.

These computing programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computing-readable medium” refers to any computing program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computing-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records 142 or data that is stored in a computing system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable and include any computing program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computing program.

In another embodiment, a computing program is provided, and the program is embodied on a computing-readable medium. In one exemplary embodiment, the system is executed on a single computing system, without requiring a connection to a server computing. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computing-executable instructions embodied in a computing-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computer and/or computing systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S. C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A virtual reality computing system for conducting instructional interactions between one or more user computing devices including a trainee computing device within a virtual environment, the computing system comprising at least one memory device and at least one processor in communication with the at least one memory device, the at least one processor configured to:
communicate with the one or more user computing devices including the trainee computing device associated with a trainee to cause the one or more user computing devices to present the virtual environment, wherein the virtual environment includes a client avatar representing a client interacting with the trainee in an instructional exercise;
receive sensor data from the trainee computing device associated with the trainee and a user computing device associated with the client during a current interaction between the trainee and the client within the virtual environment;
evaluate the current interaction between the trainee and the client by inputting the received sensor data into a trained machine learning (ML) model to generate one or more outputs including an instructional message that includes scripted text for the trainee to communicate to the client during the current interaction within the virtual environment; and
present, on the trainee computing device, the instructional message.

2. The virtual reality computing system of claim 1, wherein the at least one processor is further configured to:
build a training dataset including a plurality of historical client interaction records including interaction data and sensor data associated with each of the interaction records;
train the ML model using the training dataset; and
input interaction data from one or more past interactions associated with the trainee into the trained ML model to generate a new instructional exercise for further training of the trainee within the virtual environment using the client avatar.

3. The virtual reality computing system of claim 1, wherein the instructional message includes one or more of the following: a warning to the trainee relating to the interacting with the client, policy data associated with the instructional exercise, and/or a measured emotional state of the client determined from the sensor data of the client.

4. The virtual reality computing system of claim 1, wherein the at least one processor is further configured to:
build a training dataset including a plurality of historical client interaction records including audio and/or video interaction data between a client and a trained service provider, and sensor data associated with the corresponding client and service provider for each of the interaction records; and
train the ML model using the training dataset to recommend a subsequent suggested interaction between a client and a service provider.

5. The virtual reality computing system of claim 1, wherein the virtual environment includes an instructor avatar representing an instructor, the client avatar representing the client, and a trainee avatar representing the trainee, wherein interactions occur between the instructor, the client and the trainee within the virtual environment.

6. The virtual reality computing system of claim 1, wherein the at least one memory device stores a plurality of virtual instructional exercises, each including a virtual instructional environment for training the trainee, wherein the at least one processor is further configured to:
receive, from the trainee computing device and an instructor computing device associated with an instructor, criteria associated with an instructional exercise; based upon the criteria, determine a selected instructional exercise and an associated virtual instructional environment satisfying the criteria; and
transmit the selected instructional exercise to one or more trainee computing devices each associated with a trainee to cause the one or more trainee computing devices to present the virtual environment associated with the selected instructional exercise.

7. The virtual reality computing system of claim 1, wherein the trainee computing device includes one or more sensors for collecting the sensor data, wherein the sensors include at least one of a camera, a video, a microphone, a biometric sensor, radar, lidar, pressure sensor, temperature sensor, flow parameter sensor, and weather data.

8. The virtual reality computing system of claim 1, wherein the at least one processor is further configured to:
further train the ML model using historical client interaction records between one or more trained service providers and clients; and
generate, using the ML model, the client avatar representing the client and control the client avatar interactions with the trainee within the virtual environment.

9. The virtual reality computing system of claim 1, wherein the memory stores a plurality of virtual instruction exercises, each including a virtual instructional environment, for training a trainee, wherein the at least one processor is configured to:
select an instruction exercise from the plurality of instructional exercises for instructing the trainee, based, at least in part, one or more historical trainee interactions.

10. The virtual reality computing system of claim 1, wherein the processor is further configured to:
transmit a message to a user computing device, the message including data associated with an interaction that occurred within the virtual instructional environment, causing the user computing device to present the data outside of the virtual instructional environment.

11. The virtual reality computing system of claim 1, wherein the at least one memory stores a plurality of instructional exercises, each of the plurality of instructional exercises includes a score associated with a complexity of the instructional exercise, and wherein the processor is further configured to:
select one of the plurality of instructional exercises based on the complexity score; and
cause the selected instructional exercise to be presented within the virtual environment; and
prompt the trainee to interact with the client within the virtual environment as part of the selected instructional exercise.

12. The virtual reality computing system of claim 1, wherein the at least one processor is further configured to:
compare the sensor data to one or more trigger criterion to determine if a criterion is satisfied, and
if the sensor data satisfies the criterion, input the sensor data into the ML model to output the instruction message to the trainee for interacting with the client and control how the client avatar reacts to the interacting with the trainee.

13. A computer-implemented method for conducting interactions between a plurality of user computing devices including a trainee computing device within a virtual environment, the computer-implemented method performed by a computing device including at least one memory device and at least one processor in communication with the at least one memory device and one or more user computing devices, the computer-implemented method comprising:
communicating with the one or more user computing devices including the trainee computing device associated with a trainee to cause the one or more user computing devices to present the virtual environment, wherein the virtual environment includes a client avatar representing a client interacting with the trainee in an instructional exercise;
receiving sensor data from the trainee computing device associated with the trainee and a user computing device associated with the client during a current interaction between the trainee and the client within the virtual environment;
evaluating the current interaction between the trainee and the client by inputting the received sensor data into a trained machine learning (ML) model to generate one or more outputs including an instructional message that includes a scripted text for the trainee to communicate to the client during the current interaction within the virtual environment; and
presenting, on the trainee computing device, the instructional message.

14. The computer-implemented method of claim 13, wherein the method further comprises:
building a training dataset including a plurality of historical client interaction records including interaction data and sensor data associated with each of the interaction records;
training the ML model using the training dataset; and
inputting interaction data from one or more past interactions associated with the trainee into the trained ML model to generate a new instructional exercise for further training the trainee within the virtual environment using the client avatar.

15. The computer-implemented method of claim 13, wherein the instructional message includes one or more of the following: a warning to the trainee relating to the interacting with the client, policy data associated with the instructional exercise, and/or an emotional state of the client determine from the sensor data of the client.

16. The computer-implemented method of claim 13, wherein the method further comprises:
building a training dataset including a plurality of historical client interaction records including audio and/or video interaction data between a client and a trained service provider, and sensor data associated with the corresponding client and service provider for each of the interaction records; and
training the ML model using the training dataset to recommend a subsequent suggested interaction between a client and a service provider.

17. The computer-implemented method of claim 13, wherein the virtual environment includes an instructor avatar representing an instructor, the client avatar representing the client, and a trainee avatar representing the trainee, wherein interactions occur between the instructor, the client and the trainee within the virtual environment.

18. The computer-implemented method of claim 13, wherein the at least one memory stores a plurality of virtual instructional exercises, each including a virtual instructional environment for training the trainee, wherein the method further comprises:
receiving, from the trainee computing device and an instructor computing device associated with an instructor, criteria associated with an instructional exercise; and
based upon the criteria, determining a selected instructional exercise and an associated virtual environment, satisfying the criteria; and
transmitting the selected instructional exercise to one or more trainee computing devices each associated with a trainee to cause the one or more trainee computing devices to present the virtual environment associated with the selected instructional exercise.

19. The computer-implemented method of claim 13, wherein the trainee computing device includes one or more sensors for collecting the sensor data, wherein the sensors include at least one of a camera, a video, a microphone, a biometric sensor, radar, lidar, pressure sensor, temperature sensor, flow parameter sensor, and weather data.

20. The computer-implemented method of claim 13, wherein the method further comprises:
training the ML model using historical client interaction records between one or more trained service providers and clients; and
generate, using the ML model, the client avatar representing the client and controlling the client avatar interactions with the trainee within the virtual environment.

21. At least one non-transitory computer-readable storage media having computing-executable instructions embodied thereon for conducting instructional interactions between one or more user computing devices including a trainee computing device within a virtual environment, wherein when executed by a computing system including at least one memory device and at least one processor in communication with the at least one memory device and one or more user computing devices, the computer-executable instructions cause the at least one processor to:
communicate with the one or more user computing devices including the trainee computing device associated with a trainee to cause the one or more user computing devices to present the virtual environment, wherein the virtual environment includes a client avatar representing a client interacting with the trainee in an instructional exercise;
receive sensor data from the trainee computing device associated with the trainee and a user computing device associated with the client during a current interaction between the trainee and the client within the virtual environment;
evaluate the current interaction between the trainee and the client by inputting the received sensor data into a trained machine learning (ML) model to generate one or more outputs including an instructional message that includes scripted text for the trainee to communicate to the client during the current interaction within the virtual environment; and
present, on the trainee computing device, the instructional message.

22. The at least one non-transitory computer-readable storage media of claim 21, wherein when executed by the at least one processor, the computer-executable instructions cause the at least one processor to:
build a training dataset including a plurality of historical client interaction records including interaction data and sensor data associated with each of the interaction records;
train the ML model using the training dataset; and
input interaction data from one or more past interactions associated with the trainee into the trained ML model to generate a new instructional exercise for further training of the trainee within the virtual environment using the client avatar.
